(19) United States
(12) Patent Application Publication
(10) Pub. No.: US 2010/0068479 A1
(43) Pub. Date: Mar. 18, 2010

(54) FINE-PATTERN STRUCTURAL BODY MANUFACTURING METHOD AND FINE-PATTERN STRUCTURAL BODY

(76) Inventor: EIJI KARIYADA, Tokyo (JP)

Correspondence Address: Mr. Jackson Chen, 6535 N. STATE HWY 161, IRVING, TX, 75039, US

(21) Appl. No.: 12/537,475

(22) Filed: Aug. 7, 2009

(30) Foreign Application Priority Data
Sep. 16, 2008 (JP) 2008-236846

(51) Int. Cl. B32B 3/10; B32B 38/06

(52) U.S. Cl. 428/195.1; 156/219

(57) ABSTRACT

To provide a fine-pattern structural body manufacturing method having advantages such as excellent handling property. The fine-pattern structural body manufacturing method of the present invention includes following steps, i.e., a step of laminating a film substrate having flexibility and a mold having a fine pattern formed thereon in such a manner that one surface of the film substrate and a surface of the mold where the fine pattern is formed face with each other, a step of laminating other surface of the film substrate and a rigid substrate having rigidity, a step of separating the mold from the film substrate, a step of forming a recording film on the surface of the film substrate from which the mold is separated, a step of forming a protective film on the recording film, and a step of separating the rigid substrate from the film substrate.

### CROSS-REFERENCE TO RELATED APPLICATION

This application is based upon and claims the benefit of priority from Japanese patent application No. 2008-236846, filed on Sep. 16, 2008, the disclosure of which is incorporated herein in its entirety by reference.

### BACKGROUND OF THE INVENTION

1. Field of the Invention

The present invention relates to a manufacturing method and the like of a fine-pattern structural body that is used when conducting micro-machining on storage devices, optical devices, bio devices, semiconductor devices, etc.

2. Description of the Related Art

In accordance with rapid developments in recent digital, information society, there has been a demand for implementing mass capacity in optical disks that are typical storage devices. Accordingly, developments of such disks have been conducted vigorously in various places. In currently-commercialized Φ120 mm optical disks, the pit length is 0.1 μm-0.2 μm and the capacity thereof is about 15 GB-30 GB. However, for the next generation and the generation thereafter, it is investigated to increase the capacity by shortening the shortest pit length. For that, it is effective to fabricate the original disk by using Deep UV (ultraviolet) laser beams or electron beams. For example, it has been reported that the shortest pit length becomes about 80 nm when the Deep UV laser beams are used, and that the shortest pit length becomes about 40 nm when the electron beams are used. If the shortest pit length is about 40 nm, a capacity of about 500 GB/12 cm can be obtained.

An optical disk substrate used for such high density recording/reproduction is fabricated by an injection molding method by using a stamper to which a duplicated pattern of the original of the optical disk is transferred. Further, Japanese Unexamined Patent Publication 1-107336 (Patent Document 1) and Japanese Unexamined Patent Publication 6-103617 (Patent Document 2) disclose techniques for obtaining a stamper to which an original of an optical disk is duplicated and for obtaining a plurality of substrates. Patent Document 1 and Patent Document 2 disclose fabricating methods for obtaining the stamper and the like to which the uneven pattern of the original disk is duplicated and a plurality of substrates with the use of the stamper by using an ultraviolet curing resin.

Patent Document 1 discloses a process with which; a polytetrafluoroethylene film is provided as a mold releasing layer on the surface of the original disk in which the uneven pattern of guide grooves and information pits are formed on the surface of a photosensitive resin by using an optical device and on the surface of the stamper to which an inverted pattern of the uneven pattern of the original disk is transferred; an ultraviolet curing resin is applied on the surfaces; the original or the stamper is laminated on another base member; and after radiation of the ultraviolet rays, those are separated at the interface between the polytetrafluoroethylene film and the ultraviolet curing resin layer so as to transfer the uneven pattern of the guide grooves and the information pits to the base member.

Further, Patent Document 2 discloses a process with which; an oxide thin film is formed on the original disk surface and the stamper surface; a fluorine-based compound is applied or vapor-deposited thereon; a heat treatment is applied further to increase the contact force between the oxide thin film and the fluorine-based compound; and the surface energy of the uneven surfaces of the original disk or the stamper is decreased so as to increase the mold-releasing characteristic at the interface between the ultraviolet curing resin formed on the fluorine-based compound thin film and the fluorine-based compound thin film.

In addition to the measures taken described above, there is also a measure taken at the same time to increase a recording capacity per cartridge by housing a plurality of optical disk substrates in a single cartridge. In order to increase the recording capacity drastically by increasing the number of disks housed in a single cartridge as described above, it is necessary for the thickness of the single housed disk to be as thin as possible. Therefore, developments of thin-type optical disks with the thickness of about 100 μm per disk have been actively conducted.

As a manufacturing method of such, thin-type optical disk medium, there is a hot-press method as disclosed in Japanese Unexamined Patent Publication 6-223407 (Patent Document 3) with which: a thermoplastic resin or thermosetting resin is applied to a sheet surface having a flexibility such as PET (polyethylene terephthalate); a fine pattern of a stamper is transferred; the surface is cured by heat; and a recording film is deposited thereafter. Further, there is also a method introduced with which: an ultraviolet curing resin is applied on the surface of a flexible sheet; a fine pattern of a stamper is transferred; ultraviolet curing is conducted; and a recording film is deposited thereon.

Furthermore, Japanese Unexamined Patent Publication 2003-263792 (Patent Document 4) describes a method with which: a fine pattern of a stamper is transferred to a thin-type film (flexible sheet) by using an ultraviolet curing resin; after transferring the pattern, a rigidity-adding substrate having rigidity and a large thermal capacity is laminated on the opposite-side face of the fine-pattern transferred surface; a recording film is deposited on the fine-pattern transferred surface; the recording film is initialized; and after initializing the recording film, the rigidity-adding substrate is exfoliated from the thin-type film.

However, there are following issues with the related techniques described above.

As described above, in order to increase the recording capacity drastically by increasing the number of disks housed in a single cartridge, it is necessary for the thickness of the single housed disk to be as thin as possible. Therefore, extremely thin optical disks with the thickness of about 100 μm per disk are used actively.

With PC (polycarbonate) substrates of 0.6 mm-1.2 mm in thickness used in general for CDs (compact discs), DVDs (digital versatile discs), and the like, pattern transfer is easily executed by transferring uneven shapes on a stamper by the injection molding method. Meanwhile, it is essential to precisely adjust the filling amount of a resin material in a very small amount for fabricating the above-described extremely-thin substrates of about 100 μm. However, it is extremely difficult to control the amount of the resin in such a small amount. Therefore, it is not possible with the injection molding method to mold the film substrates of about 100 μm in thickness with a good regenerability.

Further, the pattern transferring method as disclosed in Patent Document 1 uses a polytetrafluoroethylene film as a mold-releasing accelerating layer. However, it has been observed, that a part of the polytetrafluoroethylene film formed on the original disk or the stamper surface is exfoliated during a process where a plurality of numbers of pattern transferring actions are repeated, and it is stuck to the base member to which the pattern is transferred. This happens because an external stress is applied to the interface between the original disk or the stamper and the polytetrafluoroethylene film formed thereon by the plurality of numbers of pattern transferring actions, so that a part of the polytetrafluoroethylene film comes off. When a part of the polytetrafluoroethylene film is exfoliated in this manner, that part turns out as a defect when transferring the pattern. Thus, smooth separation cannot be expected at the time of mold release after transferring the pattern.

Further, with the pattern transferring method as disclosed in Patent Document 2, the base substrate and the original disk or the stamper are separated at the interface between the fluorine-based compound thin film formed on the surface of the original disk or the stamper via the oxide thin film and the ultraviolet curing resin layer used for pattern transfer formed thereon. Thus, it is necessary for the fluorine-based compound thin film to be strongly stuck to the oxide thin film that is the base film. Further, it is necessary for the ultraviolet curing resin layer used for pattern transfer to be strongly stuck to the pattern-forming substrate. Therefore, after forming the oxide thin film on the surface of the original disk or the stamper and the fluorine-based compound is further applied by dripping or vapor deposition, it is necessary to apply a heat treatment for improving the contact property. Further, in order to increase the contact force between the ultraviolet curing resin layer used for pattern transfer and the pattern-forming substrate, it is necessary to apply an adhesive accelerator between the both. This makes the process thereof extremely complicated. Furthermore, for precisely transferring the uneven pattern formed on the original disk or the stamper, it is necessary to control the thickness of the fluorine-based compound thin film formed to decrease the surface energy to be as accurately as possible and as thin as possible. However, the above-described fluorine-based compound exhibits no sensitivity for the ultraviolet rays, so that it is necessary to apply a heat treatment after the drip feeding. Thus, the forming steps become extremely complicated, and adjustment of the film thickness becomes difficult when vapor deposition is employed.

Furthermore, since it is necessary to apply the heat treatment at a high temperature of about 100 degrees C. for improving the contact property between the oxide thin film and the fluorine-based compound thin film described above, the original disk and the stamper to be used are required to have heat-resistance characteristic for the temperature of 100 degrees C. Therefore, it is difficult to use an organic-resin type material having a low-glass transition point, e.g., PC, with this process. Moreover, a new issue has become apparent that when such process is conducted on an extremely thin film substrate of about 100 μm in thickness, the film substrate itself reacts to the adhesive accelerator, resulting in deformation and shrinkage.

Further, in Patent Document 4, center holes of 15 mm are formed at a constant pitch on a roll-type film having a separable protective film provided on one face. When transferring the pattern, positions of the center hole formed on the roll-type film and the stamper are set via a center pole. A center hole of 15 mm and a fine pattern are formed in the stamper in advance. The center pole rotates by holding the stamper. When transferring the fine pattern of the stamper, the fine pattern of the stamper is transferred while pressing a part of the above-described roll-type film by the center pole against the ultraviolet curing resin film that is spin-applied on the stamper, the ultraviolet rays are radiated from the outside, and the film and the stamper are separated after the ultraviolet curing resin is cured.

The roll-type film to which the fine pattern is transferred is then fed to an outer diameter processing device where the outer diameter is processed to a desired size on the basis of the center hole. Thereafter, there is formed a structural body in which a rigidity adding substrate, an adhesive sheet, a protective sheet, a thin-type film, and a transfer layer are stacked in this order from the center pole. After forming such structural form, the structural body is set to a vacuum device where a recording film is deposited and initialization processing is executed thereafter. Then, it is separated at the interface between the protective film and the thin-type film to obtain a thin-type optical disk.

However, it is found that there are followings issues with the pattern transferring method disclosed in Patent Document 4, With the thin-type optical disk fabricating method described above, positioning of the center hole of the film substrate formed in advance and the center hole of the stamper at the time of transferring the fine pattern of the stamper to the film substrate is determined only with the finished size accuracy of the center pole of the same diameter. For the center hole in size of 15 mm formed in the film substrate and the stamper, the center hole of the center pole that can be smoothly inserted and taken out needs to be formed in a size that is smaller than 15 mm by about 30-50 μm. Therefore, shift between the center position of the film and the center position, of the stamper, i.e., the eccentric amount, becomes about 30-50 μm. In addition, there is normally an eccentric amount of 20-40 μm between the stamper and the fine pattern formed on the stamper. Considering this, the eccentric amount becomes about 90 μm at the most. It is therefore found that the obtained thin-type optical disk is hard to record or reproduce information correctly. For example, the eccentric amount is defined to be 50 μm or less in the next-generation HD (High Definition) DVD optical disks.

Further, when the pattern is transferred by bringing the ultraviolet curing resin layer that is spin-applied to the stamper surface to be in contact with the film substrate in the air, it is likely to have air bubbles mixed between the film and the ultraviolet curing resin layer at the moment when the ultraviolet curing resin layer formed on the stamper makes contact with the film substrate to be laminated with each other. It is found that such air bubbles exist as defects when transferring the pattern.

Further, as described above, when the structural body in which the rigidity adding substrate, the adhesive sheet, the protective sheet, the thin-type film, and the transfer layer are stacked in this order from the center pole is set to the vacuum device for depositing the recording film, the air bubbles between the rigidity adding substrate and the adhesive sheet, between the adhesive sheet and the protective sheet, and between the protective sheet and the thin-type film are inflated under a decompressed atmosphere in the vacuum device. When the recording film is deposited under such inflated state, the inflated part becomes deformed because of a thermal stress applied at the time of depositing the film. This deformation occurs in a state with an increase in the temperatures, so that it remains as a defect even after the structural body is exposed to the air after depositing the film. It is therefore found that, as a result, the deformation influences the signal quality at the time of recording and reproduction, as the substrate defect of the thin-type optical disk. It is typical to add the adhesive sheet and the protective sheet in the air, and micro air bubbles exist necessarily between the adhesive sheet as well as the protective sheet and the thin-type film substrate to which it is laminated. Thus, those air bubbles under the decompression atmosphere can cause the defects.

Further, Patent Document 4 describes to process the external diameter of the film substrate by using the external diameter processing device after transferring the fine pattern to the thin-type film. That is, since the thin-type film has flexibility and limberness. Thus, it is hard to be handled at the time of external diameter processing. In order to overcome such issue, Patent Document 4 mentions about transferring the fine pattern to the thin-type film, performing the external diameter processing, and laminating a substrate having rigidity onto the surface that is on the opposite side from the pattern transferring surface thereafter. When laminating the substrate, it is necessary to apply pressure from the fine-pattern transferred surface. Thus, there is disclosed a method which laminates a cover sheet on the time-pattern transferred surface in addition, and laminates a rigidity adding substrate on the back side of the film substrate. However, with this method, it is necessary to laminate the cover sheet for protecting the pattern in addition on the surface where the fine pattern is transferred. Thus, it is found that there are increased numbers of defects generated due to deformations and breaks in the fine pattern and due to mixture of fine particles and the like at the time of laminating the cover sheet.

### SUMMARY OF THE INVENTION

The present invention has been designed in view of the aforementioned issues. It is therefore an exemplary object of the present invention to provide a fine-pattern structural body manufacturing method and the like, which provide advantages such as an excellent handling property.

A fine-pattern structural body manufacturing method according to an exemplary aspect of the invention includes: laminating a first film substrate having flexibility and a mold having a fine pattern formed thereon in such a manner that one surface of the first film substrate and a surface of the mold where the fine pattern is formed face with each other; laminating other surface of the first film substrate and a first rigid substrate having rigidity; separating the mold from the first film substrate; forming a functional thin film on the surface of the first film substrate from which the mold is separated; forming a protective film on the functional thin film; and separating the first rigid substrate from the first film substrate. A fine-pattern structural body according to another exemplary aspect of the invention is manufactured by using the fine-pattern structural body manufacturing method according to the present invention.

### BRIEF DESCRIPTION OF THE DRAWINGS

FIGS. 1A-1C snow first sectional views showing manufacturing steps according to a first exemplary embodiment;

FIGS. 2D and 2E show second sectional views showing manufacturing steps according to the first exemplary embodiment;

FIGS. 3F and 3G show third sectional views showing manufacturing steps according to the first exemplary embodiment;

FIGS. 4H and 4I show fourth sectional views showing manufacturing steps according to the first exemplary embodiment;

FIG. 5J shows a fifth sectional view showing manufacturing steps according to the first exemplary embodiment;

FIG. 6 is a sectional view showing a laminating step of a first film substrate and a mold according to the first exemplary embodiment;

FIGS. 7A and 7B show plan views of FIG. 6 viewed from the above;

FIGS. 8A-8C show first sectional views showing manufacturing steps according to a second exemplary embodiment;

FIGS. 9D and 9E show second sectional views showing manufacturing steps according to the second exemplary embodiment;

FIGS. 10F and 10G show third sectional views showing manufacturing steps according to the second exemplary embodiment;

FIGS. 11H and 11I show fourth sectional views showing manufacturing steps according to the second exemplary embodiment;

FIG. 12J shows a fifth sectional view showing manufacturing steps according to the second exemplary embodiment;

FIG. 13K shows a sixth sectional view showing manufacturing steps according to the second exemplary embodiment;

FIG. 14I shows a seventh sectional view showing manufacturing steps according to the second exemplary embodiment;

FIGS. 15M and 15N show eighth sectional views showing manufacturing steps according to the second exemplary embodiment;

FIG. 16 is sectional view showing a laminating step of a first film substrate and a first rigid substrate according to the second exemplary embodiment;

FIG. 17 is a sectional view showing a laminating step of a first film substrate and a second film substrate according to the second exemplary embodiment;

FIG. 18 is a sectional view showing a laminating step of the first film substrate and the first rigid substrate according to the second exemplary embodiment;

FIGS. 19A and 19B show sectional views showing contact forces at interfaces between each substrate according to the second exemplary embodiment;

FIG. 20A shows a first sectional view showing a manufacturing step according to a third exemplary embodiment;

FIG. 21B shows a second sectional view showing a manufacturing step according to the third exemplary embodiment;

FIGS. 22C and 22D show third sectional views showing manufacturing steps according to the third exemplary embodiment;

FIGS. 23E and 23F show fourth sectional views showing manufacturing steps according to the third exemplary embodiment;

FIG. 24A shows a first sectional view showing a manufacturing step according to a fourth exemplary embodiment;

FIGS. 25B and 25C show second sectional views showing manufacturing steps according to the fourth exemplary embodiment;

FIGS. 26D and 26E show third sectional views showing manufacturing steps according to the fourth exemplary embodiment;

FIGS. 27A-27C show first sectional views showing manufacturing steps according to a fifth exemplary embodiment;

FIGS. 28D and 28E show second sectional views showing manufacturing steps according to the fifth exemplary embodiment;

FIGS. 29F and 29G show third sectional views showing manufacturing steps according to the fifth exemplary embodiment; and

FIGS. 30H and 30I show fourth sectional views showing manufacturing steps according to the fifth exemplary embodiment.

### DETAILED DESCRIPTION OF THE EXEMPLARY EMBODIMENTS

In each exemplary embodiment described hereinafter, a transparent stamper on which an optical disk pre-format or lands/grooves are formed is used as a mold. For the transparent stamper, a stamper obtained by forming a pattern on quartz glass or a stamper obtained by forming a pattern on a PC (polycarbonate) substrate is used as appropriate. For a film substrate, a flexible PC film substrate of about 75 μm-120 μm in thickness, a PET (polyethylene terephthalate) film substrate, or an amorphous polyolefin film substrate is used as appropriate. Further, for the rigid substrate having rigidity, a PC substrate of 1.2 mm in thickness with a dummy groove manufactured in a large amount by injection molding is used. Furthermore, for each ultraviolet curing resin used in each exemplary embodiment, an ultraviolet curing resin from which bubbles are eliminated in vacuum before being applied is used. The bubbles are eliminated in vacuum in order to prevent micro bubbles that are rarely mixed when injecting the ultraviolet curing resin into an applying device from entering into the applied ultra curing resin.

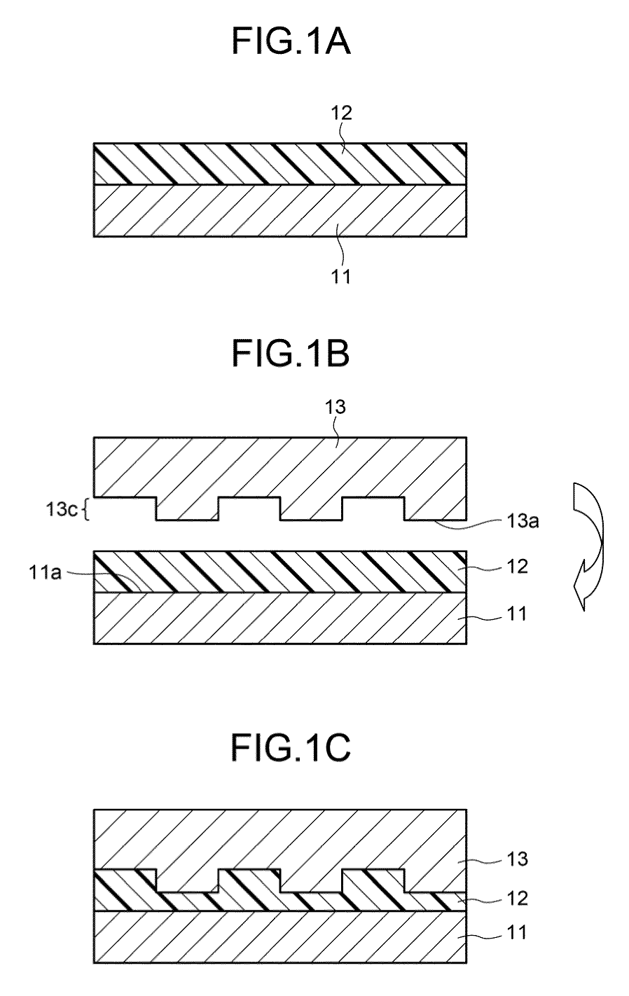

FIG. 1A-FIG. 5J are sectional views showing manufacturing steps according to a first exemplary embodiment. First, the outline of the exemplary embodiment will be described by referring to those drawings.

The fine-pattern structural body manufacturing method according to the first exemplary embodiment includes following steps. The fine-pattern structural body according to the first exemplary embodiment is manufactured by using the following steps.

A step of laminating a first film substrate 11 with flexibility and a mold 13 on which a fine pattern 13c is formed by having one face 11a of the film, substrate 11 and a surface 13a of the mold 13 on which the fine pattern 13c is formed facing with each other (FIG. 1A, FIG. 1B, FIG. 1C).

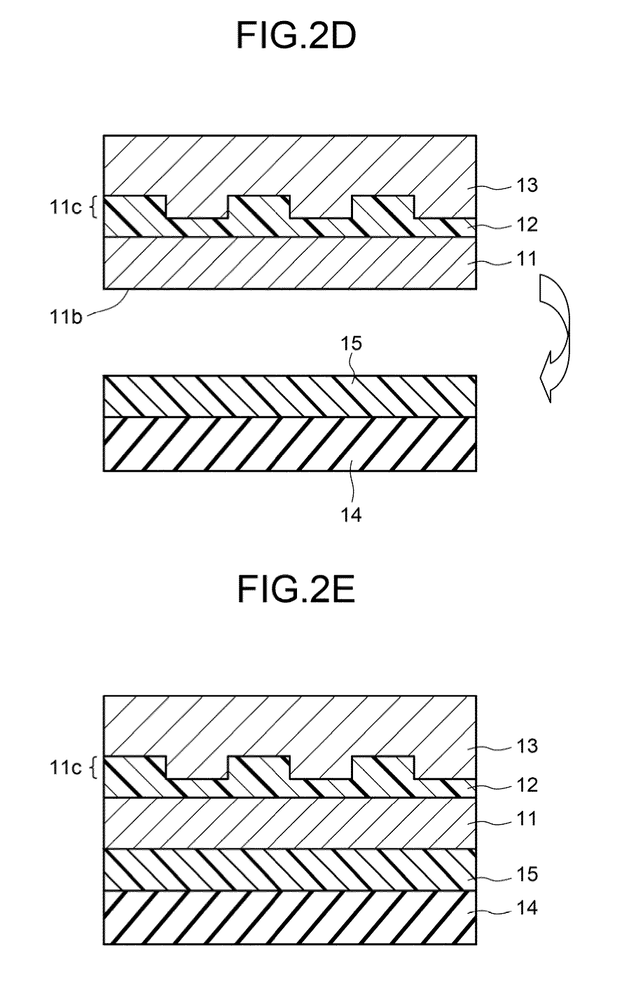

A step of laminating other surface 11b of the film substrate 11 and a first rigid substrate 14 having rigidity (FIG. 2D, FIG. 2E).

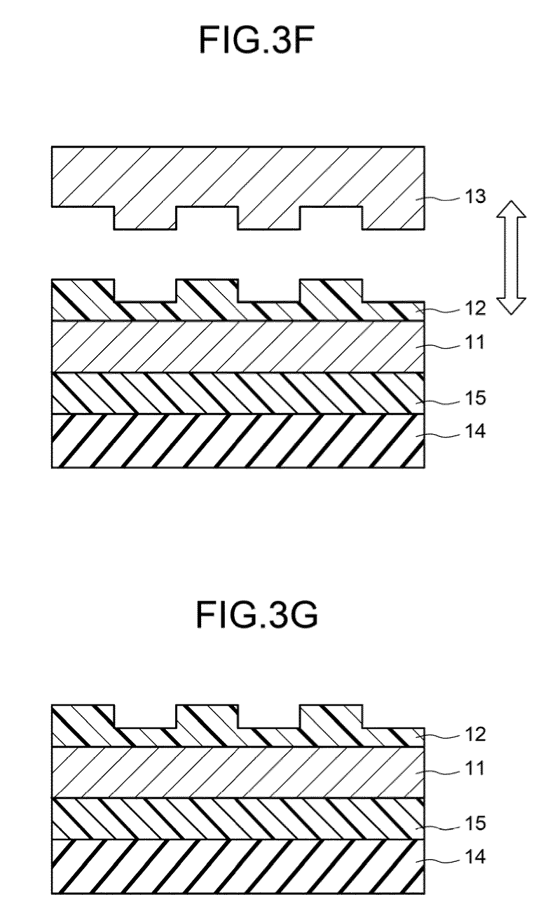

A step of separating the mold 13 from the film substrate 11 (FIG. 3F, FIG. 3G).

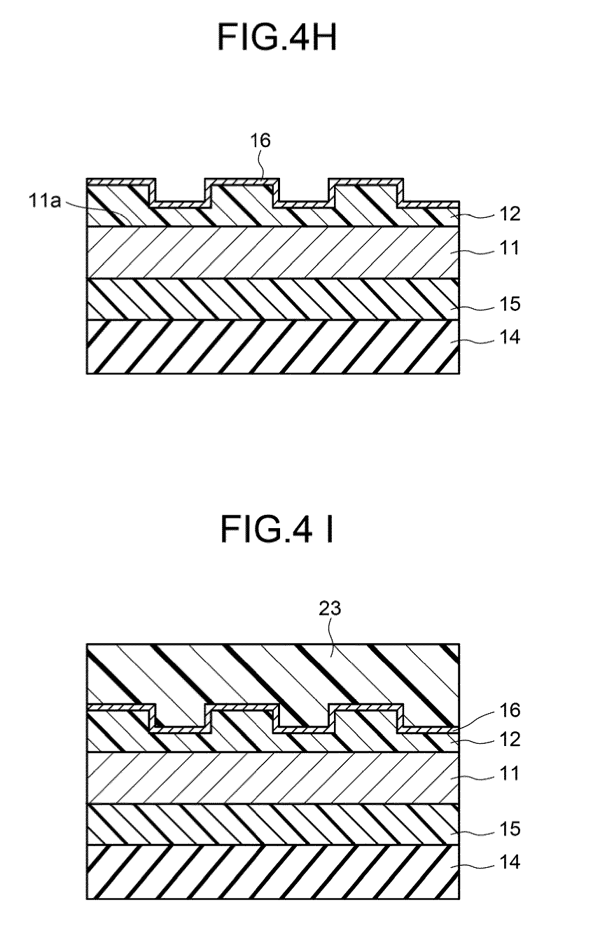

A step of forming a recording film 16 as a functional thin film on the surface 11a of the film substrate 11 after the mold 13 is separated (FIG. 4H).

A step of forming a protective film 23 on the recording film 16 (FIG. 4I).

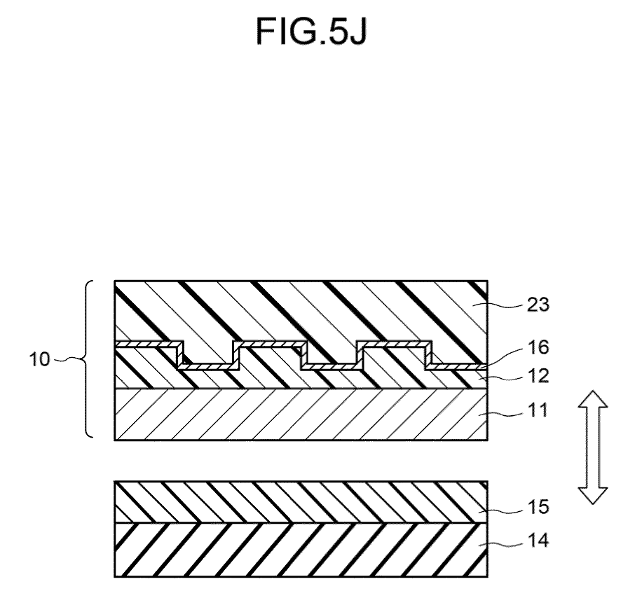

A step of separating the rigid substrate 14 from the film substrate 11 (FIG. 5J).

Next, functions and effects of the first exemplary embodiment will be described.

In the first exemplary embodiment, the rigid substrate 14 is laminated on the film substrate 11 before separating the mold 13 from the film substrate 11. Thus, a handling property of the film substrate 11 can be improved in the steps executed after separating the mold 13 from the film substrate 11. Meanwhile, in the related technique (Patent Document 4), the rigid substrate is laminated to the film substrate after separating the mold from the film substrate. Therefore, it is difficult to handle the film substrate in the steps after separating the mold from the film substrate until laminating the rigid substrate to the film substrate.

In the first exemplary embodiment, a fine-pattern transferred surface 11c (FIG. 2) of the film substrate 11 is protected by the mold 13 when pressurizing the film substrate 11 and the rigid substrate 14 for laminating the rigid substrate 14 to the film substrate 11 before separating the mold 13 from the film substrate 11. Thus, a step of forming a cover sheet on the fine-pattern transferred surface 11c of the film substrate 11 is unnecessary. Meanwhile, in the related technique (Patent Document 4), the rigid substrate is laminated to the film substrate after separating the mold from the film substrate. Therefore, a step of forming a coversheet is required for protecting the fine-pattern transferred surface of the film substrate when pressurizing the rigid substrate to be laminated.

Further, for laminating those, an ultraviolet curing resin that is described later may be used, for example. The functional thin film may be the recording film 16 as described above, for example, and the recording film 16 is an optical information recording film to/from which information can be recorded/reproduced by radiating laser beams. The thickness of the film substrate 11 is preferable to be 300 μm or less. With this, the flexibility of the film substrate 11 becomes prominent, so that the effects of the exemplary embodiment become prominent as well.

Hereinafter, the first exemplary embodiments of the invention will be described in more details and in a concretive manner by referring to FIG. 1A-FIG. 5J. In the first exemplary embodiment, a stamper obtained by forming a pattern on quartz glass is used as the mold, and a PST film of 100 μm in thickness is used as the film substrate. Hereinafter, pattern transfer to the film substrate, formation of the functional thin film, and the procedure for fabricating the fine-pattern structural body using those will be described.

FIG. 1A: A first ultraviolet curing resin 12 is applied and spread on the film substrate 11.

FIG. 1B: The mold 13 is laminated to the film substrate 11 on which the ultraviolet curing resin 12 is applied and spread.

FIG. 1C: The ultraviolet curing resin 12 is cured by radiating the ultraviolet rays from outside.

FIG. 2D: A second ultraviolet curing resin 15 is applied and spread on the rigid substrate 14.

FIG. 2E: The film substrate 11 and the rigid substrate 14 are laminated via the surface having the ultraviolet curing resin 15 applied thereon, and the ultraviolet rays are radiated to cure the ultraviolet curing resin 15.

FIG. 3F: The mold 13 is separated at the laminated interface between the ultraviolet curing resin 12 and the mold 13.

FIG. 3G: The film substrate 11 having the fine pattern formed on the ultraviolet curing resin 12 and being backed with the rigid substrate 14 via the ultraviolet curing resin 15 is placed within a chamber of a spattering device (not shown), and the air is evacuated.

FIG. 4H: After completing the evacuation, a prescribed functional thin film is deposited. Here, formed is the recording film 16 (optical information recording film) including a write-once recording layer that can record only once.

FIG. 4I: The ultraviolet curing resin is applied and spread on the recording film 16, and the ultraviolet rays are radiated to cure the ultraviolet curing resin so as to form a protective film 23.

FIG. 5J: The rigid substrate 14 is separated at the laminated interface between the film substrate 11 and the ultraviolet curing resin 15. The procedure described above can fabricate a fine structural body 10 in which the fine pattern is transferred onto the flexible film substrate 11 and also the recording film 16 as the functional thin film is formed.

FIG. 1A-FIG. 5J are used to describe the concept of the process for transferring the fine pattern. That is, those drawings visually illustrate the positional relation regarding the film substrate, the rigid substrate, the mold, and each ultraviolet curing resin, and do not show the actual sizes and the ratios thereof. In particular, in the drawings, the ultraviolet curing resin is applied only on one of the surfaces to be laminated. However, in practice, there are cases where the ultraviolet curing resin is applied to the other surface or to the both surfaces. Those cases are selected as appropriate by considering the readiness of the process. Discussed in this paragraph also applies to the other exemplary embodiments as well.

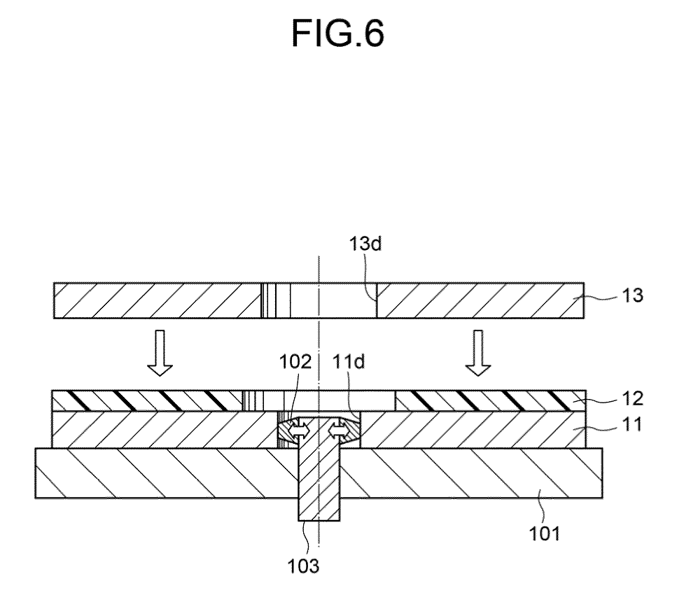

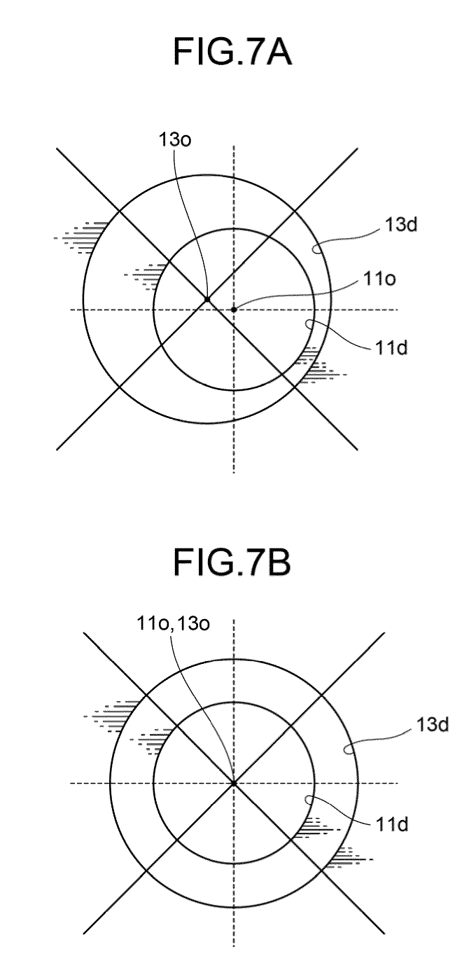

FIG. 6 is a sectional view showing a step of laminating the first film substrate and the mold according to the first exemplary embodiment. FIGS. 7A and 7B show plan views of FIG. 6 taken from the above, in which FIG. 7A is a case where the film substrate does not match with the mold, and FIG. 7B is a case where the film substrate matches with the mold. Explanations will be provided hereinafter by referring to those drawings.

First, the outline will be described. FIG. 6 shows steps of FIG. 1A and FIG. 1B in a more specific manner. In the first exemplary embodiment, a center point 11o of the film substrate 11 and a center point 13o of the mold 13 are derived, and the film substrate 11 and the mold 13 are laminated in such a manner that the center points 11o and 13o match with each other.

In the first exemplary embodiment, the film substrate 11 and the mold 13 are laminated in such a manner that the center points 11o and 13o of the both match with each other. Thus, the laminating accuracy can be improved. In the meantime, in the related technique (Patent Document 4), the positions are aligned by simply letting the film substrate and the mold go through a center pin. Therefore, the laminating accuracy is deteriorated.

Further, the film substrate 11 and the mold 13 have circular through holes 11d and 13d at the respective centers thereof. The relation in terms of the size of the diameters of the through holes 11d and 13d is expressed as “through hole lid<through hole 13d”. With this, the through holes 11d and 13d can be viewed from the above the mold 13 while the mold 13 is placed over the film substrate 11, so that optical positioning can be done easily.

Hereinafter, this will be described in more details. FIG. 6 shows the details of a state when the film substrate 11 and the mold 13 are laminated to transfer the fine pattern. First, the ultraviolet curing resin 12 is applied and spread on the film substrate 11. This process is executed by a typical ultraviolet curing resin applying device (not shown). The film substrate 11 after the ultraviolet curing resin 12 is being spread is placed on a table 101 shown in FIG. 6, a centering jig 102 is inserted into the through holes 11d (bore) of the film substrate 11, and a center pin 103 that can be freely placed in and out of the centering jig 102 is adjusted. That is, the film substrate 11 is centered and fixed by applying pressure from the center point 11o of the through hole 11d of the film substrate 11 towards the outside by the center pin 103. The centering jig 102 is obtained by reforming a micrometer. Through rotating the centering jig 102, the center pin 103 placed in six equally distributed manner can be taken in and out of the centering jig 102.

Subsequently, in a sate where the film substrate 11 is being centered and fixed, coordinates of three arbitrary points in the fringe of the through hole 11d are read by using an optical microscope (not shown) from the above to find the center point 11o of the film substrate 11. When the coordinates of three points in the circumference are known, the coordinates of the center of the circle can be obtained from the equation of a circle. Subsequently, the mold 13 is placed to face the film substrate 11, coordinates of three arbitrary points of the fine pattern (or three arbitrary points in the fringe of the through hole 13d) formed on the mold 13 are read by using the optical microscope (not shown) from the above to obtain the coordinates of the center point 13o of the mold 13.

Alternatively, the film substrate 11 and the mold 13 may be set simultaneously, the three arbitrary points in the fringe of the through hole 11d of the film substrate 11 may be read through the through hole 13d of the mold 13 to obtain the coordinates of the center point 11o of the film substrate 11, and then the coordinates of the center point 13o of the mold 13 may be obtained by reading the three arbitrary points of the fine pattern (or three arbitrary points in the fringe of the through hole 13d) formed on the mold 13.

Then, the mold 13 is moved so that the center point 13o of the mold 13 and the center point 11o of the film substrate 11 match with each other, and the mold 13 is brought down at the position where the center points 11o and 13o of the both match with each other to be laminated to the film substrate 11, FIGS, 7A and 7B provide a conceptual diagram (FIG. 7A) of a case where the center point 11o of the film substrate 11 is shifted from the center point 13o of the mold 13, and a conceptual diagram (FIG. 7B) of a case where the center points match with each other.

A series of devices described above are set within the chamber that can evacuate the air. The inside the chamber is evacuated to a vacuum state (about 10 Pa) at the stage where the center points 11o and 13o of the film substrate 11 and the mold 13 are brought to match with each other, and the mold 13 is brought down to laminate the both. After laminating the both, the ultraviolet rays are irradiated via a quarts glass window on the upper part of the chamber to cure the ultraviolet curing resin 12. Thereafter, the inside the chamber is returned to an atmospheric pressure, and the laminated film substrate 11 and the mold 13 are collected.

The advantages of this method are as follows. First, the laminating actions are conducted in vacuum, so that the air bubbles are not mixed in the ultraviolet curing resin 12 sandwiched between the mold 13 and the film substrate 11 when laminating those. Second, before laminating the film substrate 11 and the mold 13, each of those is centered individually, and the center coordinates of the mold 13 are moved to meet the center coordinates of the film substrate 11 to be laminated. Thus, the center points 11o and 13o of the both match with each other, thereby making it possible to reduce eccentricity as much as possible on the film substrate 11 to which the fine pattern is transferred. Hereinafter, the laminating method employing this will be expressed as “vacuum laminating method”.

It is found that the eccentricity amount at the time of transferring the fine pattern from the mold 13 to the film substrate 11 becomes about 5-10 μm with the vacuum laminating method. Note that while the fine pattern is formed on the laminating face of the mold 13, it is not illustrated in FIG. 6.

As described above, after the ultraviolet curing resin 12 is applied and spread on the film substrate 11, the film substrate 11 is fixed on the table 101, and the mold 13 to be laminated is placed above, it is desirable for the inner diameter of the film substrate 11 to be smaller than the inner diameter of the mold 13 in order to obtain the coordinates of the three arbitrary points in the inner diameter of the film substrate 11 for deriving the center point 11o of the film substrate 11 while the mold 13 is placed thereabove. This is to derive the center point 11o of the film substrate 11 by measuring the coordinates of the three arbitrary points in the inner diameter of the film substrate 11 with the optical microscope through a through hole 13d of the mold 13. The reason is that, if the inner diameter of the mold 13 is smaller than that of the film substrate 11, it is necessary to measure the coordinates of the three arbitrary points in the inner diameter of the film substrate 11 through the mold 13 with the optical microscope, and a measurement error may be generated. Therefore, it is desirable to use the film substrate 11 and the mold 13 which are in a relation satisfying “the inner diameter of the film substrate 11<the inner diameter of the mold 13”.

As in the laminating step of the film substrate 11 and the mold 13, accurate position alignment (centering) may also be conducted in the laminating step of the film substrate 11 and the rigid substrate 14 (FIGS. 2D and 2E). This step conforms to that of FIG. 6, so that illustrations thereof are omitted. The center point of the film substrate 11 and the center point of the rigid substrate 14 are derived, and the film substrate 11 and the rigid substrate 14 are laminated in such a manner that the center points match with each other. The film substrate 11 and the rigid substrate 14 have circular through holes at respective centers thereof, and those are in a relation of “through hole of the film substrate 11<through hole of the rigid substrate 14”. With this, the both through holes can be viewed from the above the rigid substrate 14 in a state where the rigid substrate 14 is being placed over the film substrate 11, so that optical position alignment becomes easy.

With the present invention, the first rigid substrate is laminated on the first film substrate before separating the mold from the first film substrate. Thus, as an exemplary advantage according to the invention, the handling property of the first film substrate in the steps after separating the mold from the first film substrate can be improved. Further, through laminating the first rigid substrate to the first film substrate before separating the mold from the first film substrate, the fine-pattern transferred surface of the first film substrate can be protected with the mold when laminating the first rigid substrate. Therefore, it is possible to omit the step of forming the cover sheet on the fine-pattern transferred surface of the first film substrate.

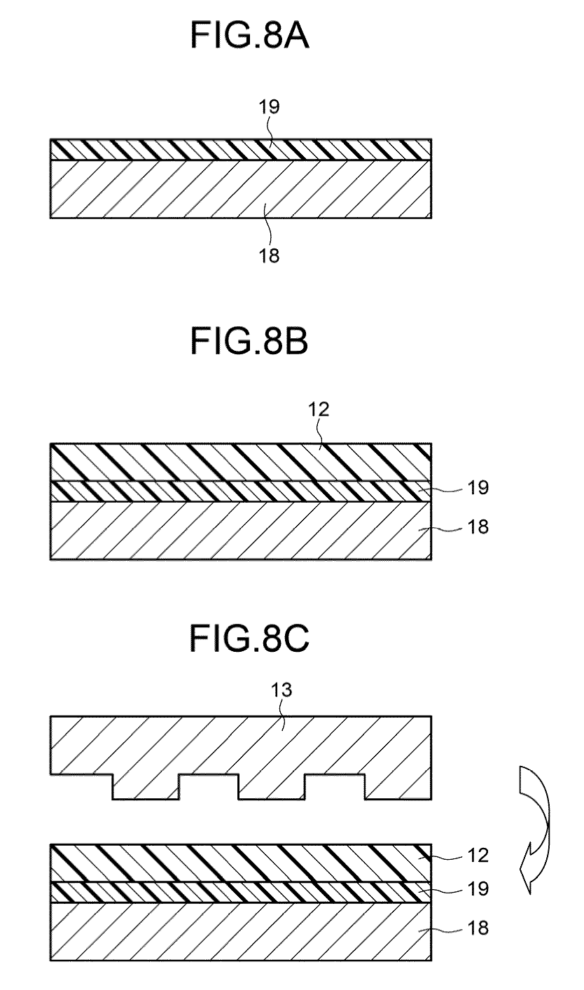

FIG. 8A-FIG. 15N are sectional views showing manufacturing steps according to a second exemplary embodiment. First, the outline of the second exemplary embodiment will be described by referring to those drawings.

The second exemplary embodiment includes following steps instead of the step (FIG. 4I) which forms the protective film 23 on the recording film 16 of the first exemplary embodiment, and achieves the similar functions and effects as those of the first exemplary embodiment.

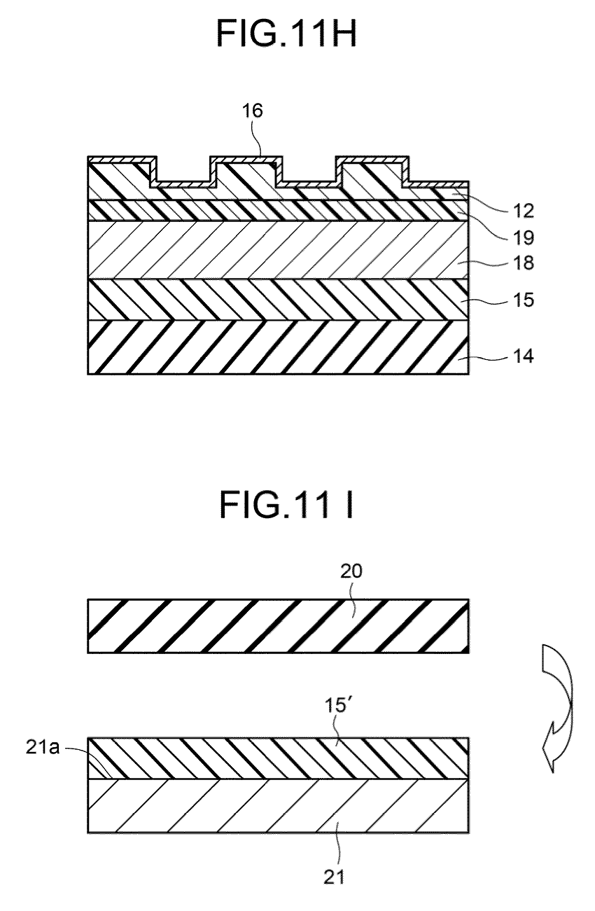

A step of laminating one surface 21a of a second film substrate 21 and a second rigid substrate 20 having rigidity (FIG. 11I).

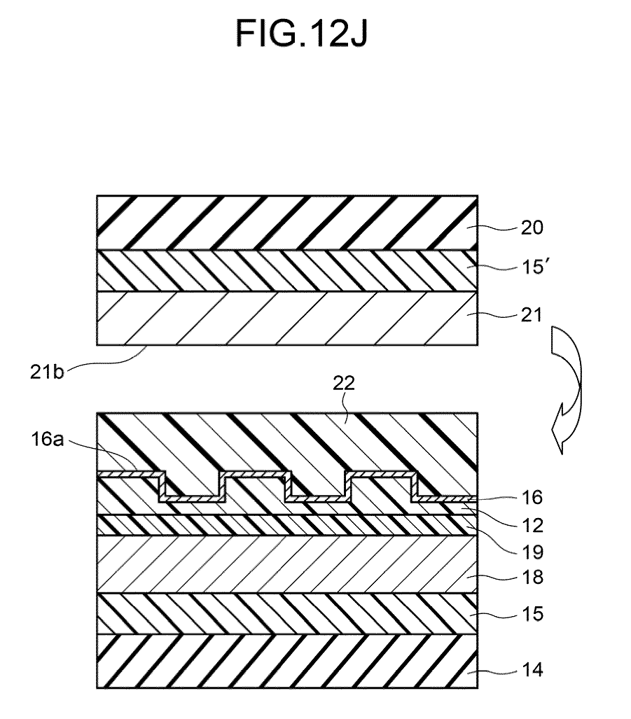

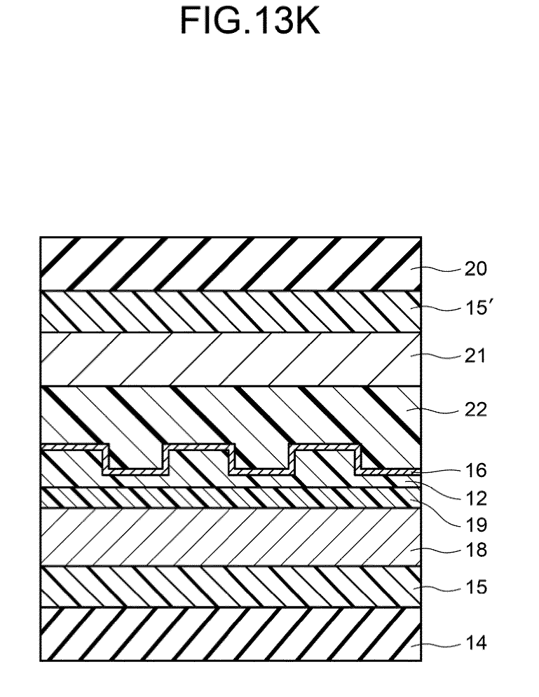

A step of laminating one surface 16a on a first film substrate 13 on which the recording film 16 is formed and other surface 21b of the film substrate 21 (FIG. 12J and FIG. 13K).

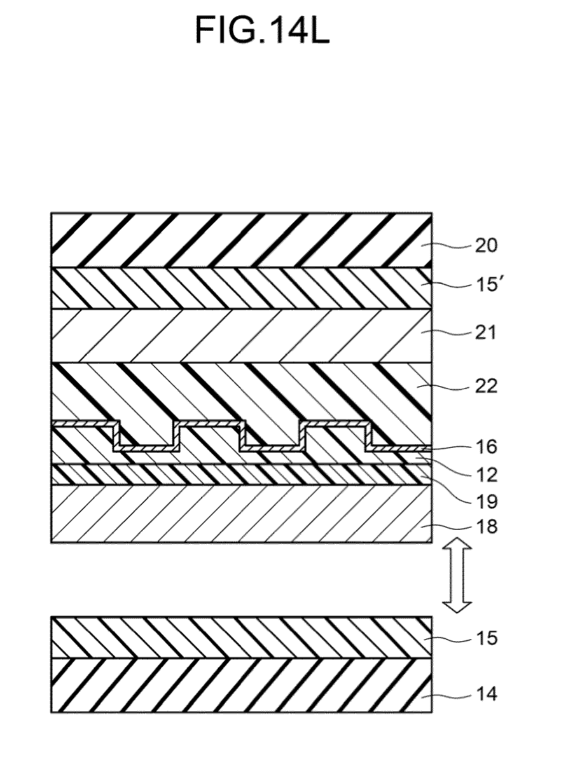

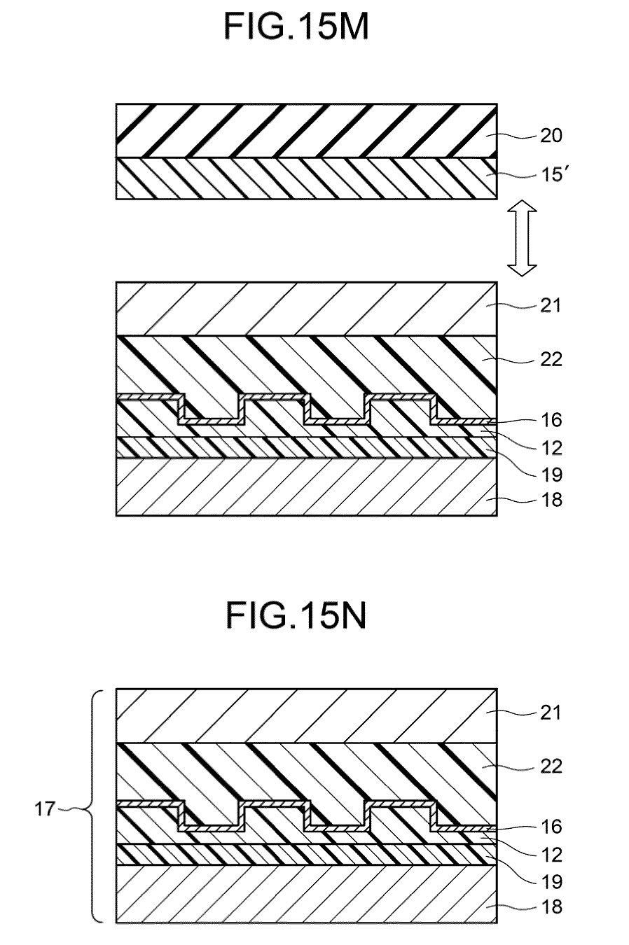

A step of separating the first rigid substrate 14 and the second rigid substrate 20 respectively from the film substrate 18 and the film substrate 21 (FIG. 14L and FIG. 15M).

It is desirable for the thickness of the film substrate 21 to be 300 μm or less. With this, the flexibility of the film substrate 21 becomes prominent, so that the effects of the exemplary embodiment become prominent as well. Other structures, functions, and effects are same as those of the first exemplary embodiment.

Hereinafter, the second exemplary embodiment will be described in more details. The second exemplary embodiment describes a case in which a PC stamper obtained by forming a land/groove fine pattern for an optical disk on a PC substrate of 1.2 mm in thickness is used as a mold, and a PC film substrate of 92 μm in thickness fabricated by an extrusion method is used as a film substrate. Hereinafter, pattern transfer to the film substrate, formation of a functional film, and a procedure of fabricating a fine-pattern structural body using those will be described.

FIG. 8A: A fourth ultraviolet curing resin 19 is applied and spread on the first film substrate 18, and the ultraviolet rays are radiated to cure the ultraviolet curing resin 19.

FIG. 8B: The first ultraviolet curing resin 12 is applied and spread on the fourth ultraviolet curing resin 19.

FIG. 8C: The mold 13 is pressed against the surface where the ultraviolet curing resin 12 is applied.

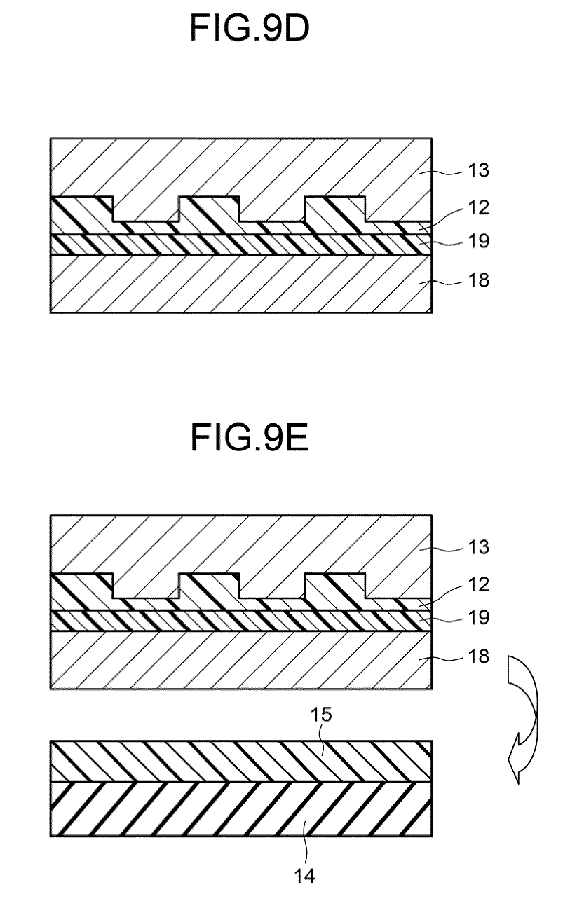

FIG. 9D: After pressing the mold 13, the ultraviolet curing resin 12 is cured by radiating the ultraviolet rays.

FIG. 9E: The second ultraviolet curing resin 15 is applied and spread on the first rigid substrate 14, and the rigid substrate 14 is laminated, via the ultraviolet curing resin 15, to the surface of the film substrate 18 where nothing is formed.

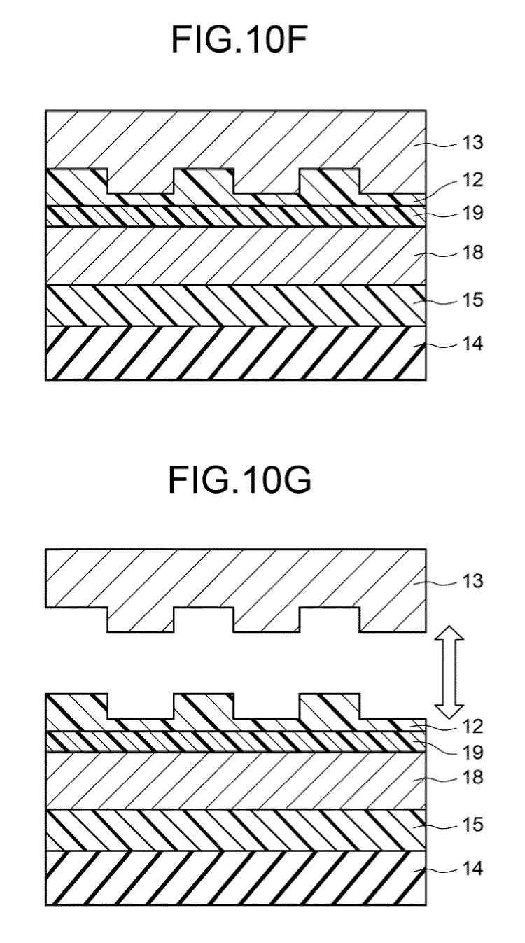

FIG. 10F: After laminating the film substrate 18 to the rigid substrate 14, the ultraviolet curing resin 15 is cured by radiating the ultraviolet rays.

FIG. 10G: The mold 13 is separated at the interface between the mold 13 and the ultraviolet curing resin 12.

FIG. 11H: The air inside a film-depositing device is evacuated. At a point where it reaches a desired vacuum degree, a desired functional thin film is deposited on the fine-pattern surface of the film substrate 18. Here, formed is the recording film 16 (optical information recording film) including a write-once type recording layer that is capable of reading only once.

FIG. 11I: A second ultraviolet curing resin 15′ is applied and spread on the second film substrate 21, and the film substrate 21 and the second rigid substrate 20 are laminated via the ultraviolet curing resin 15′. Subsequently, the ultraviolet curing resin 15′ is cured by radiating the ultraviolet rays.

FIG. 12J: A third ultraviolet curing resin 22 is applied and spread on the recording film 16 that is obtained in the step of FIG. 11H, and the film substrate 21 obtained in the step of FIG. 11I is laminated via the ultraviolet curing resin 22.

FIG. 13K: The ultraviolet curing resin 22 is cured by radiating the ultraviolet rays.

FIG. 14L: The rigid substrate 14 is separated at the interface between the ultraviolet curing resin 15 and the film substrate 18.

FIG. 15M: The rigid substrate 20 is separated at the interface between the ultraviolet curing resin 15′ and the film substrate 21.

FIG. 15M: At last, a fine-pattern structural body 17 in which the flexible film substrates 18 and 21 are laminated is obtained.

In the second exemplary embodiment, the PC film substrate is used as the film substrate. Thus, as described above, the ultraviolet curing resin 19 is inserted on the film substrate 18 as a deposited strengthening layer for improving the contact property between the film substrate 18 and the ultraviolet curing resin 12. This is because a resin containing fluoromonomers that can be finely released from the mold 13 is used as the ultraviolet curing resin 12. In the first exemplary embodiment, the PET substrate is used as the film substrate. However, the PET substrate exhibits fine contact property with the ultraviolet curing resin containing the fluoromonomers. Therefore, no such deposited strengthening layer is provided.

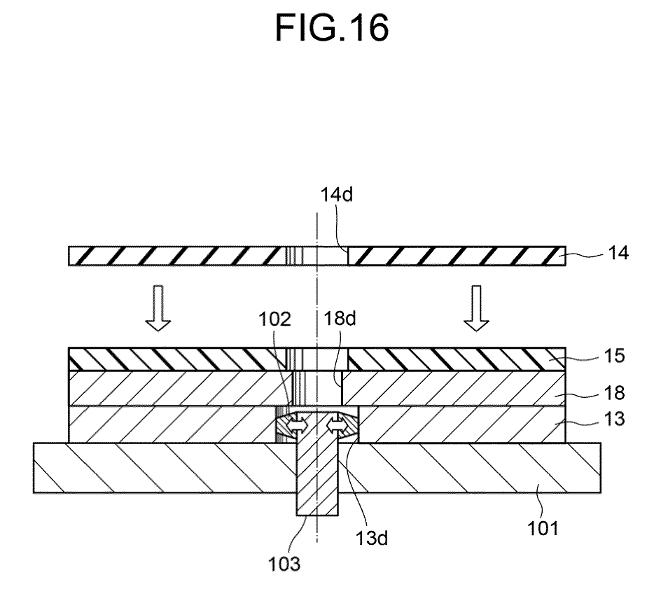

FIG. 16 is a sectional view showing a laminating step of the first film substrate and the first rigid substrate according to the second exemplary embodiment. Hereinafter, explanations will be provided by referring to the drawing.

First, the outline will be described. FIG. 16 shows the step of FIG. 9E in a more specific manner. In the second exemplary embodiment, a center point of the film, substrate 18 and a center point of the rigid substrate 14 are derived, and the film substrate 18 and the rigid substrate 14 are laminated in such a manner that the center points thereof match with each other.

In the second exemplary embodiment, the film substrate 18 and the rigid substrate 14 are laminated in such a manner that the both center points of the film substrate 18 and the rigid substrate 14 match with each other. Thus, the laminating accuracy can be improved. In the meantime, in the related technique (Patent Document 4), the positions are aligned by simply letting the film substrate and the rigid substrate go through a center pin. Therefore, the laminating accuracy is deteriorated.

Further, the film substrate 18 and the rigid substrate 14 have circular through holes 18d and 14d at the respective centers thereof. The relation in terms of the size of the diameters of the through holes 18d and 14d is expressed as “through hole 18d<through hole 14d”. With this, the through holes 18d and 14d can be viewed from the above the rigid substrate 14 while the rigid substrate 14 is placed over the film substrate 18, so that optical positioning can be done easily.

Hereinafter, this will be described in more details. As shown in FIG. 9E, the film substrate 18 is laminated to the mold 13 via the ultraviolet curing resin 15. FIG. 16 is a conceptual diagram showing the centering and laminating of the both substrates, when the film substrate 18 and the rigid substrate 14 are laminated via the ultraviolet curing resin 15. In FIG. 16, only the mold 13, the film substrate 18, the ultraviolet curing resin 15, and the rigid substrate 14 are illustrated for simplification.

As in the case of the first exemplary embodiment, a relation of “the inner diameter of the mold 13>the inner diameter of the film substrate 13” is satisfied. Thus, as shown in FIG. 16, centering is conducted on the table 101 by using the inner diameter of the mold 13, and the mold 13 is fixed with the center pin 103. Since the film substrate 13 is laminated to the mold 13, there is no way that the mold 13 becomes shifted after it is fixed. The ultraviolet curing resin 15 is applied and spread on the film substrate 18 (or the rigid substrate 14) in advance.

Subsequently, the rigid substrate 14 is placed on the upper side thereof and fixed, and the center points of the respective inner diameters of the rigid substrate 14 and the film substrate 18 are obtained by the same method as described above. Then, the substrates are superimposed and laminated in such a manner that the center points of the both match with each other. The laminating step and the step of radiating the ultraviolet rays are executed in vacuum in the same manner as the one described above. In that case, it is desirable for the inner diameter of the rigid substrate 14 to satisfy a relation of “the inner diameter of rigid substrate 14>the inner diameter of the film substrate 18” so that the inner diameter of the rigid substrate 14 does not become an obstacle for measuring the inner diameter of the film substrate 18. The relation in terms of the size of the inner diameter of the mold 13 and the inner diameter of the rigid substrate 14 is not so important, so that those sizes may be selected as appropriate. Therefore, it is desirable for the relation in terms of the size of the inner diameter of the film substrate 18, the inner diameter of the mold 13, and the inner diameter of the rigid substrate 14 to satisfy the following relation.

(Inner diameter of Film substrate 18<Inner diameter of Mold 13) and (Inner diameter of Film substrate 18<Inner diameter of Rigid substrate 14)

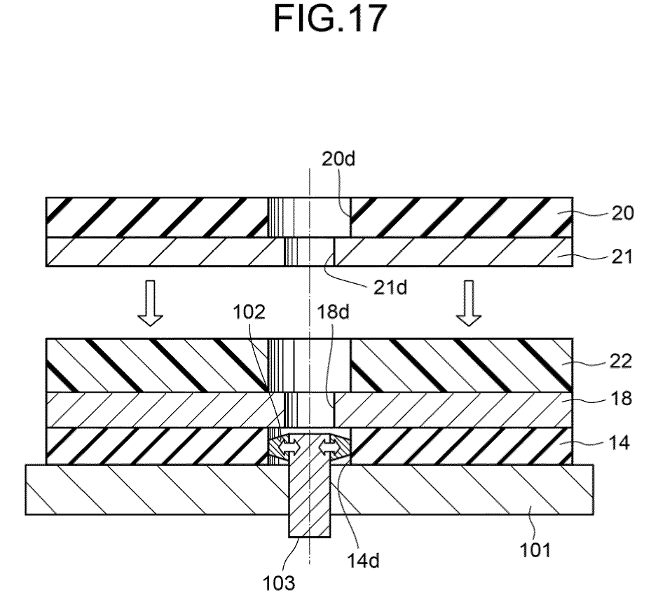

FIG. 17 is a sectional view showing a laminating step of the first film substrate and the second film substrate according to the second exemplary embodiment of the invention. Hereinafter, explanations will be provided by referring to the drawing.

First, the outline will be described. FIG. 17 shows the step of FIG. 12J in a more specific manner. In the second exemplary embodiment, a center point of the film substrate 18 and a center point of the film substrate 21 are derived, and the film substrate 18 and the film substrate 21 are laminated in such a manner that the center points thereof match with each other.

In the second exemplary embodiment, the film substrate 18 and the film substrate 21 are laminated in such a manner that the both center points of the film substrate 18 and the film substrate 21 match with each other. Therefore, the laminating accuracy can be improved. Further, the film substrate 18 and the film substrate 21 have circular through holes 18a and 21d at the respective centers thereof. The relation in terms of the size of the diameters of the through holes 18d and 21d can be expressed as “through hole 18d=through hole 21d”.

This will be described in more details hereinafter. Described is how centering and laminating of each substrate can be conducted in the laminated state shown in FIG. 12J. FIG. 17 shows a conceptual diagram. FIG. 17 shows the illustration by paying attention only to the rigid substrate 14, the film substrate 18, the ultraviolet curing resin 22, the film substrate 21, and the rigid substrate 20 for simplification.

As shown in FIG. 17, the rigid substrate 14 is placed on the table 101 to be in contact therewith, and centering and fixation of the rigid substrate 14 and the film substrate 18 are conducted by utilizing the inner diameter of the rigid substrate 14 through the center pin 103. The ultraviolet curing resin 22 is applied and spread in advance by another device.

Subsequently, the film substrate 21 laminated to the rigid substrate 20 is set to the laminating device with the rigid substrate 21 side facing down. As can be seen from FIG. 17, the film substrate 18 and the film substrate 21 have through holes 18d and 21d of a same inner diameter. For the centering conducted in this case, three arbitrary points of the inner diameter of the film substrate 18 set on the table 101 can be measured by slightly shifting the film substrate 21 set on the upper side to the left and right sides. Thereby, the center point thereof can be derived. Subsequently, the center point of the film substrate 21 on the upper side is derived. Then, the substrates may be laminated by adjusting the position of the film substrate 21 on the upper side in such a manner that the center points of both substrates overlap with each other.

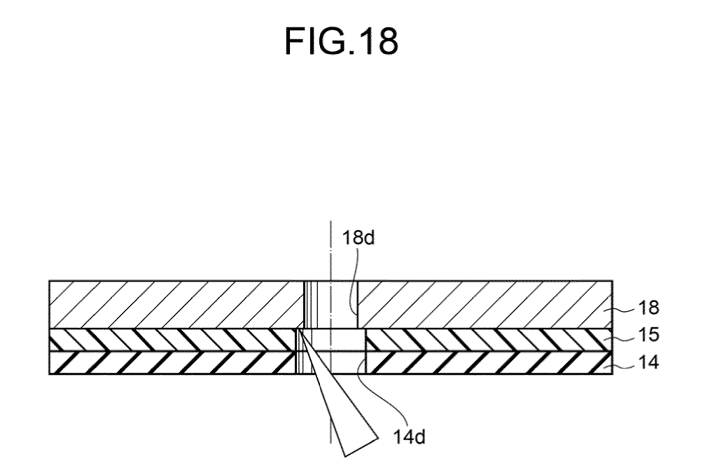

FIG. 18 is a sectional view showing a separation step of the first film substrate and the first rigid substrate according to the second exemplary embodiment of the invention. Hereinafter, explanations will be provided by referring to the drawing.

A method for separating the film substrates 18, 21 respectively from the ultraviolet curing resins 15, 15′ shown in FIG. 14L and FIG. 15M will be described hereinafter. FIG. 18 shows a case where the film substrate 18 is separated from the ultraviolet curing resin 15. FIG. 18 shows enlarged views of only the rigid substrate 14, the ultraviolet curing resin 15, and the film substrate 18. According to the relation in terms of the size of the inner diameter of the film substrate 18 and the inner diameter of the rigid substrate 14 as described above, the inner diameter of the film substrate 18 is smaller than the inner diameter of the rigid substrate 14 as shown in the drawings. Thus, the end part of the through hole 18d of the film substrate 18 is projected towards the inner side than the end part of the through hole 14d of the rigid substrate 14. It has been verified that the film substrate 18 can be cleanly separated from the adhesive interface between the ultraviolet curing resin 15 and itself through spraying compressed air to that part by guiding the air concentratedly from outside by a needle or the like. The film substrate 21 may be separated in the same manner.

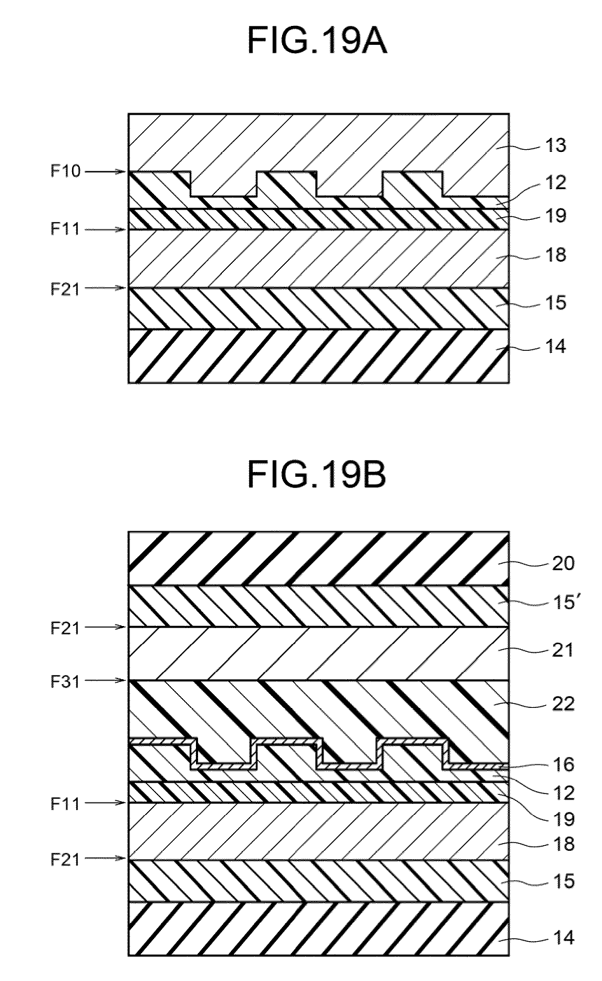

FIGS. 19A and 19B snow sectional views showing the contact forces at the interfaces of each substrate according to the second exemplary embodiment. Hereinafter, explanations will be provided by referring to the drawing.

There are a plurality of processes for executing the above-described separation, other than the one described above. The relation regarding the each section to be separated and the contact force at each contact point will be described by using FIG. 19. FIG. 19A shows a case where the mold 13 is separated at the interface between the pattern-forming ultraviolet curing resin 12 and itself.

It is assumed that the contact force at the interface between the mold 13 and the ultraviolet curing resin 12 is F10, the contact force at the interface between the ultraviolet curing resin 19 and the film substrate 18 is F11, and the contact force at the interface between the film substrate 18 and the ultraviolet curing resin 15 is F21. Here, for the mold 13 to be separated from the interface between the ultraviolet curing resin 12 and itself, it is necessary to satisfy the relations of “F10<F11” and “F10<F21”.

In order to satisfy the relations above, various kinds of resins have been tested as the ultraviolet curing resin 12. As a result, it has been experimentally found that the fluoromonomer containing ultraviolet curing resin is most suitable. With a normal acryl-type ultraviolet curing resin, the water contact angle at the surface after being cured is about 50-70 degrees. However, the contact angle with the fluoromonomer containing ultraviolet curing resin exceeds 100 degrees, and it is found that the mold releasing property thereof is extremely good. Therefore, it is desirable to use the fluoromonomer containing ultraviolet curing resin as the ultraviolet curing resin 12. In the case of using the acryl-based ultraviolet curing resin, the ultraviolet rays were radiated after pressuring the mold 13 to cure the ultraviolet curing resin, and separation thereof was tried at the interface. However, the mold 13 and the film substrate 13 were strongly fixed to each other, and it was difficult to separate.

FIG. 19B shows a case where the ultraviolet curing resin 15 and the film substrate 18 are separated at the interface thereof, and the ultraviolet curing resin 15′ and the film substrate 21 are separated at the interface thereof.

It is assumed that the contact force at the interface between the ultraviolet curing resin 15′ and the film substrate 21 as well as the contact force at the interface between the film substrate 18 and the ultraviolet curing resin 13 are F21, respectively, the contact force at the interface between the film substrate 21 and the ultraviolet curing resin 22 is F31, and the contact force at the interface between the ultraviolet curing resin 19 and the film substrate 18 is F11. Here, in order to separate the ultraviolet curing resin 15′ and the film substrate 21 at the interface thereof and to separate the film substrate 18 and the ultraviolet curing resin 15 at the interface thereof, it is necessary to satisfy the relations of “F21<F31” and “F21<F11”.

In order to satisfy such relations, it is desirable to use materials with which the modulus of elasticity of the ultraviolet curing resins 15, 15′ becomes higher than that of the ultraviolet curing resins 22, 19. This is because the ultraviolet resin with the high modulus of elasticity exhibits higher hardness after being cured compared to the ultraviolet curing resin with low modulus of elasticity, so that it can be exfoliated easily from the film substrate when radiating the compressed air to the separating interface. In the meantime, the ultraviolet curing resin with the low modulus of elasticity exhibits low hardness even after being cured, and exhibits high viscosity. Thus, it is easy to cause separation at the contact interface that uses such ultraviolet curing resin. As described above, in a case where the PC film made with a polycarbonate material is used as the film substrate 18, it is desirable to provide the ultraviolet curing resin 19 as a deposited layer before applying the ultraviolet curing resin 12. Therefore, in order to satisfy the above-described relations, it is desirable to use the materials with which the modulus of elasticity of the ultraviolet curing resin 15 becomes higher than that of the ultraviolet curing resins 22, 12, 19. In the first and the second exemplary embodiments described above, the ultraviolet curing resins having the modulus of elasticity in the range shown in a table below are used.

| NO. (Reference numerals) | Modulus of Elasticity (MPa) |
|---|---|
| Second ultraviolet curing resins 15, 15′ | 2000-2500 |
| Third ultraviolet curing resin 22 | 1000-1500 |
| Fourth ultraviolet curing resin 19 | 500-1000 |
| First ultraviolet curing resin 12 | 1000-1500 |

It has been experimentally verified that the use of the above-described ultraviolet curing resins makes it possible to implement separations at desired positions without any problems. The reasons that the ultraviolet curing resins 15 and 15′ attach to the rigid substrates 14, 20 but do not attach to the film substrates 18, 21 at the time of separation are considered as follows. On the rigid substrates 14 and 20, the dummy groove is formed by injection molding. Thus, the area of the rigid substrates 14 and 20 to be in contact with the ultraviolet curing resins 15 and 15′ is larger than that of the film substrates 18 and 21 where no pattern is formed. Therefore, when separating the film substrates 18, 21 and the rigid substrates 14, 20, those are separated while the ultraviolet curing resins 15, 15′ are laminated to the rigid substrates 14, 20. For confirmation, the same experiment was conducted by using a flat rigid substrate having no dummy groove formed thereon. As a result, it was confirmed that the ultraviolet curing resins 15 and 15′ attach to the film substrates 18 and 21 with a 50% probability. Therefore, it can be considered that the view described above is correct.

With the exemplary embodiments described above, it is possible to provide a fine-pattern structural body manufacturing method having following characteristics and a fine-pattern structural body obtained by using the same. (1) Handling of the film substrate becomes easy, since the film substrate is supported by the rigid substrate simultaneously with transfer and formation of the fine pattern. (2) It is unnecessary to provide a protection sheet or the like again on the surface with the transferred pattern, after forming and transferring the fine pattern. (3) The film substrate is laminated to the rigid substrate and supported thereby via the ultraviolet curing resin. Thus, even when it is set in vacuum, there is no air bubble generated in the laminated surface. Therefore, it is possible to obtain a fine pattern without a defect. (4) When transferring the pattern, the mold and the film substrate to which the fine pattern is transferred can be laminated by having the center points thereof matched with each other. Therefore, there is no risk of having eccentricity.

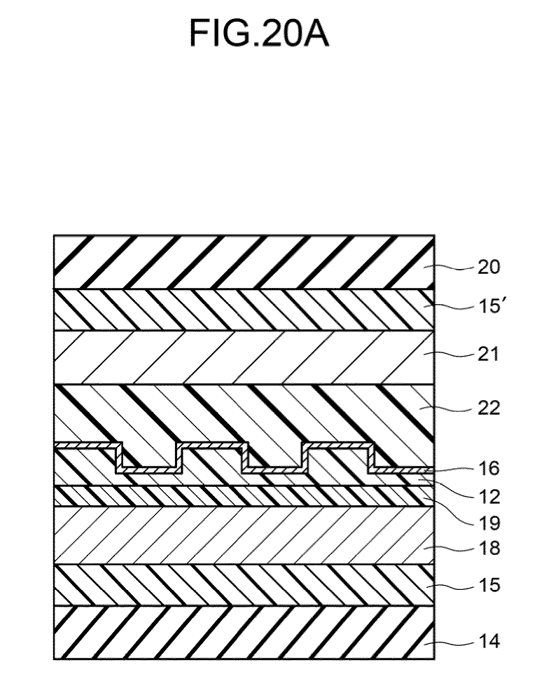

FIG. 20A-FIG. 23F are sectional views showing manufacturing steps according to a third exemplary embodiment. First, the outline of the third exemplary embodiment will be described by referring to those drawings.

The third exemplary embodiment includes following steps when separating the rigid substrates 14 and 20 from the film substrates 18 and 21, respectively, and provides the same functions and effects as those of the first and second exemplary embodiments.

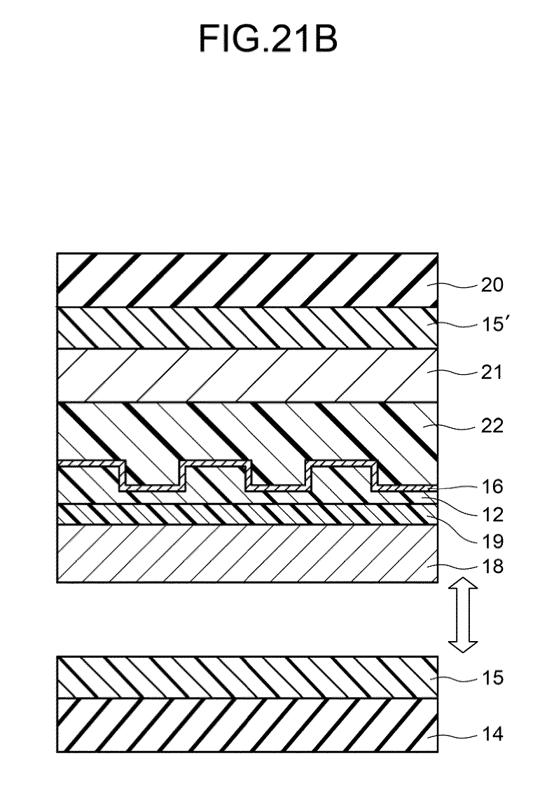

A step of separating the rigid substrate 14 from the film substrate 18 (FIG. 21B).

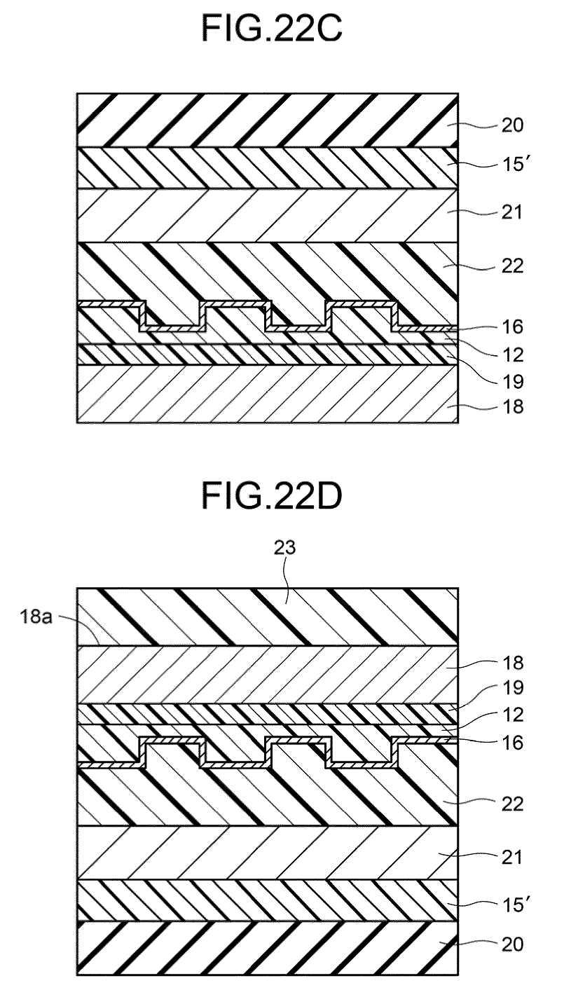

A step of forming the protective film 23 on one surface 18a of the film substrate 18 (FIG. 22D).

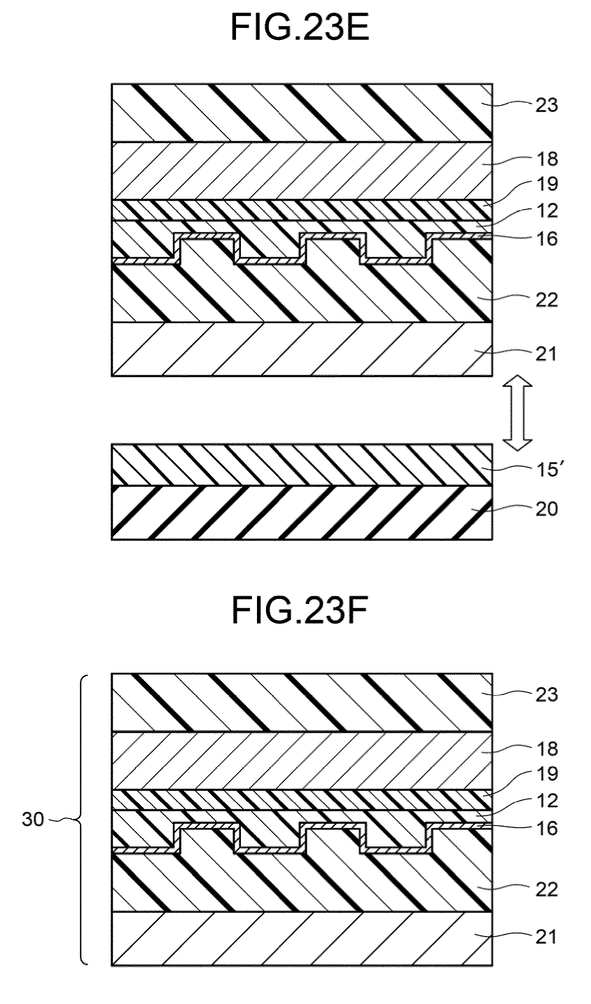

A step of separating the rigid substrate 20 from the film substrate 21 (FIG. 23E).

Hereinafter, the third exemplary embodiment will be described in more details. In the third exemplary embodiment, a protective film 23 made with an ultraviolet curing resin for protecting the film substrate is provided on the back face of one of the film substrates of the laminated medium in which the film substrates 18 and 21 shown in the second exemplary embodiments are laminated. As the mold 13, used is a PC stamper obtained by forming an optical disk land/groove fine pattern on a PC substrate of 12 mm in thickness. As the film substrates 18 and 21, used are PC film substrates of 92 μm in thickness fabricated by extrusion. As the rigid substrates 14 and 20, used are PC substrates of 1.2 mm in thickness with a dummy groove manufactured in a large amount by injection molding, as in the case of the above-described exemplary embodiments.

First, described is a procedure of a case where the protective film 23 made with the ultraviolet curing resin is provided on the back surface of the film substrate 18. The method for transferring the pattern on the film substrate 18 and the laminating method to the film substrate 21 are the same methods as those of the second exemplary embodiment. Thus, the procedure thereof will be described starting from the laminated state shown in FIG. 13K. FIG. 20A-FIG. 23F show the process for providing the protective film 23 on the back surface of the film substrate 13.

FIG. 20A: A state where the film substrate 18 and the film substrate 21 are laminated.

FIG. 21B: Separation is conducted at the interface between the film substrate 18 and the ultraviolet curing resin 15.

FIG. 22C: A state of a point where separation is conducted at the interface between the film substrate 18 and the ultraviolet curing resin 15.

FIG. 22D: After applying and spreading the ultraviolet curing resin for the protective film 23 on the film substrate 18, the ultraviolet curing resin is cured by radiating the ultraviolet rays.

FIG. 23E: Separation is conducted at the interface between the film substrate 21 and the ultraviolet curing resin 15.

Through the procedures described above, the protective film 23 can be formed on the film substrate 18 as in FIG. 23F, and a fine-pattern structural body 30 can be obtained. With this method, the ultraviolet curing resin for the protective film 23 used for protection from scars generated by a contact with an optical head and the like can be applied easily to the surface of the film substrate 18 which re cords/reproduces information by radiation of laser beams.

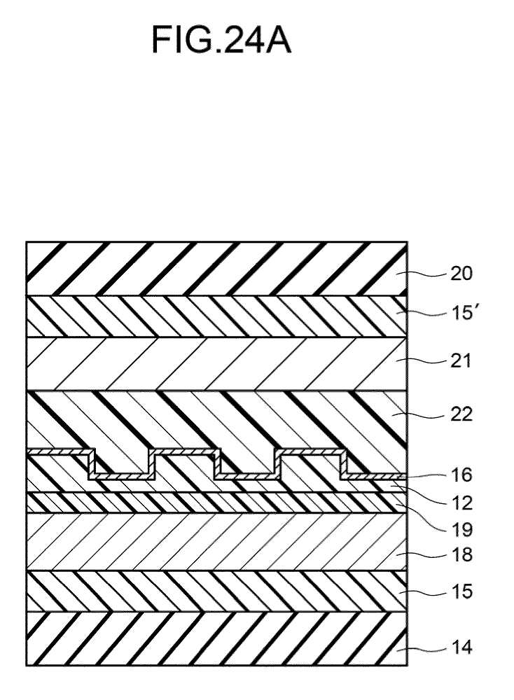

FIG. 24A-FIG. 26E are sectional views showing manufacturing steps according to a fourth exemplary embodiment. First, the outline of the fourth exemplary embodiment will be described by referring to those drawings.

The fourth exemplary embodiment includes following steps when separating the rigid substrates 14 and 20 from the film substrates 18 and 21, respectively, and provides the same functions and effects as those of the first to third exemplary embodiments.

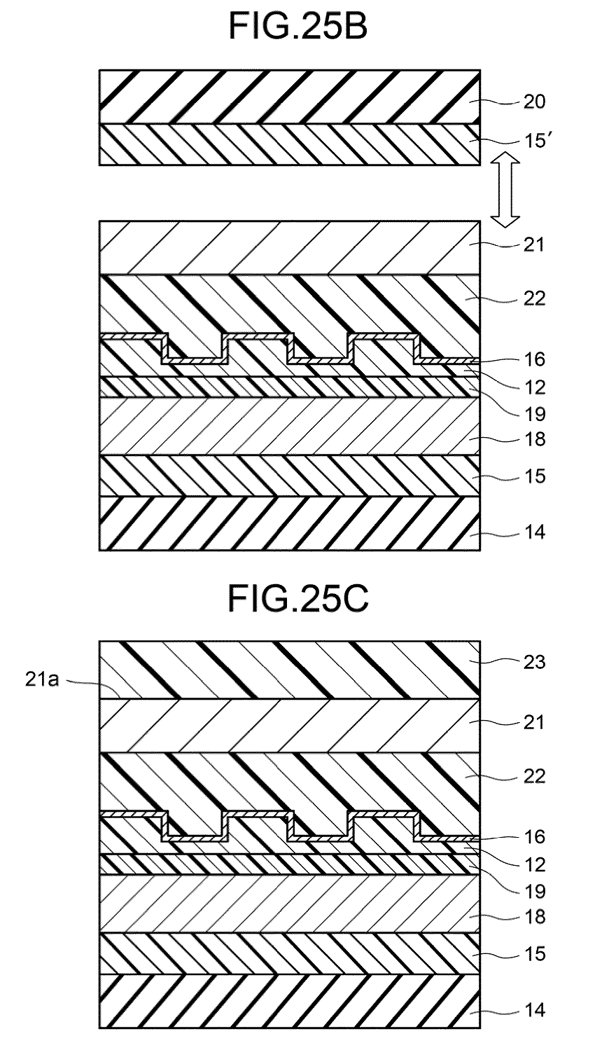

A step of separating the rigid substrate 20 from the film substrate 21 (FIG. 25B).

A step of forming the protective film 23 on one surface 21a of the film substrate 21 (FIG. 25C).

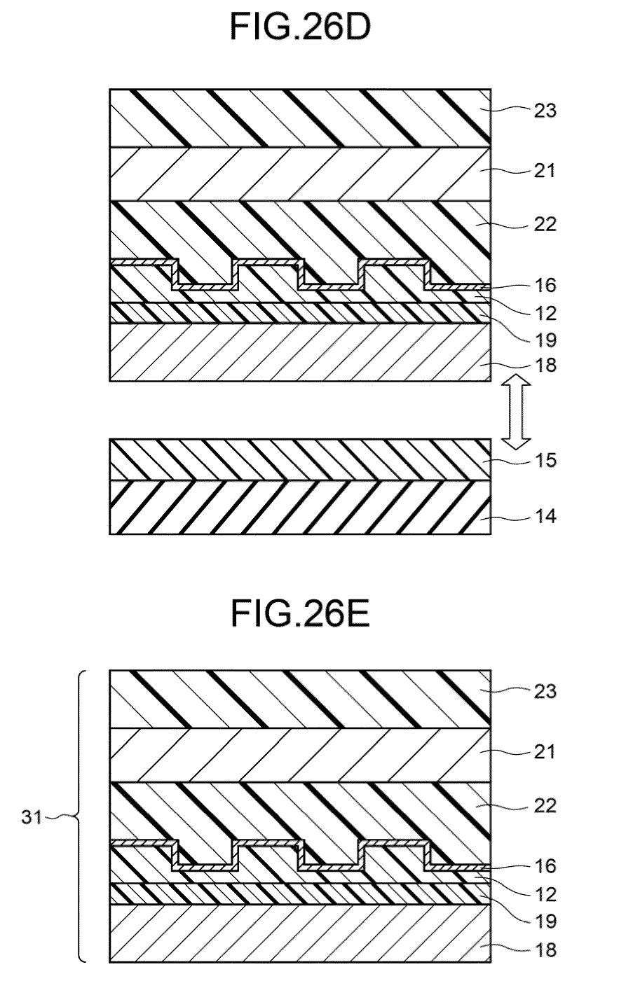

A step of separating the rigid substrate 14 from the film substrate 18 (FIG. 26D).

Hereinafter, the fourth exemplary embodiment will be described in more details. Described is a procedure of a case where the protective film 23 made with the ultraviolet curing resin is provided on the back surface of the film substrate 21. The method for transferring the pattern on the film substrate 18 and the laminating method to the film substrate 21 are the same method as those of the second exemplary embodiment. Thus, the procedure thereof will be described starting from the laminated state shown in FIG. 13K. FIG. 24A-FIG. 26E show the process for providing the protective film 23 on the back surface of the film substrate 18.

FIG. 24A: A state where the film substrate 18 and the film substrate 21 are laminated.

FIG. 25B: Separation is conducted at the interface between the film substrate 21 and the ultraviolet curing resin 15′.

FIG. 25C: After applying and spreading the ultraviolet curing resin for the protective film 23 on the film substrate 21, the ultraviolet curing resin is cured by irradiating the ultraviolet rays.

FIG. 26D: Separation is conducted at the interface between the film substrate 18 and the ultraviolet curing resin 15.

Through the procedures described above, the protective film 23 can be formed on the film substrate 21 as in FIG. 26E, and a fine-pattern structural body 31 can be obtained. With this method, the ultraviolet curing resin for the protective film 23 used for protection from scars generated by a contact with an optical head and the like can be applied easily to the surface of the film substrate 21 which records/reproduces information by radiation of laser beams.

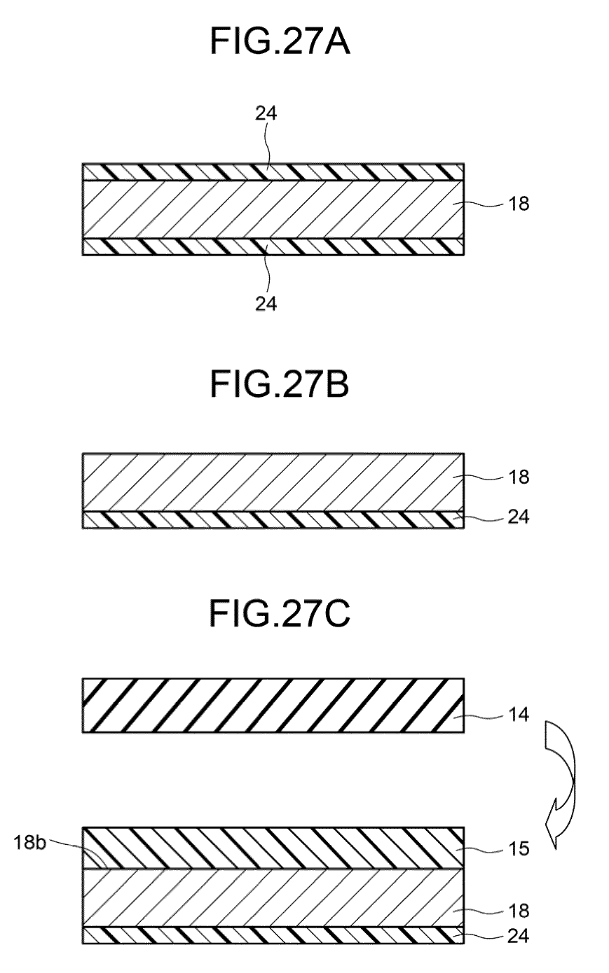

FIG. 27A-FIG. 30I are sectional views showing manufacturing steps according to a fifth exemplary embodiment. First, the outline of the fifth exemplary embodiment will be described by referring to those drawings.

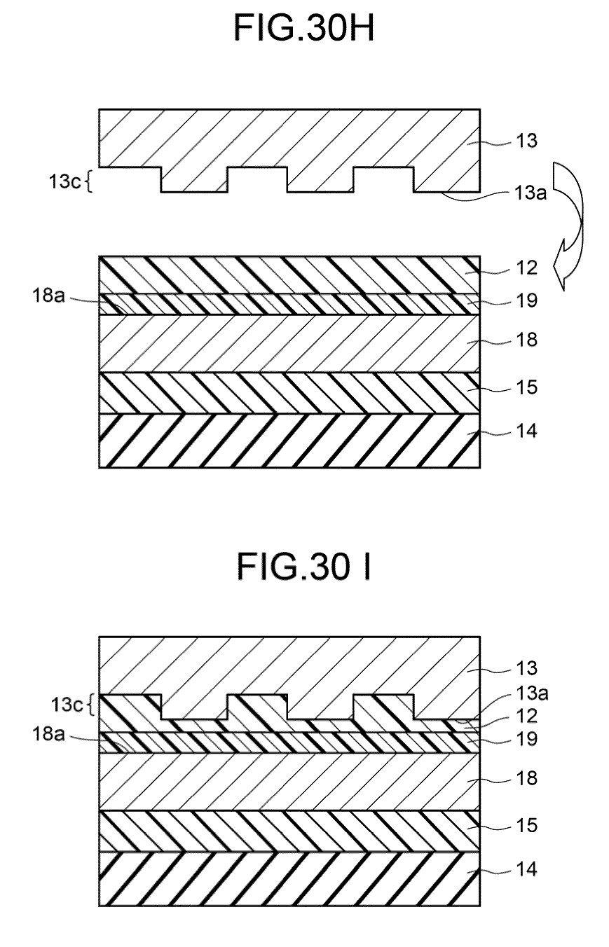

In the first exemplary embodiment, the film substrate 11 and the mold 13 are laminated while having one surface 11a of the film substrate 11 opposed to the surface 13a of the mold 13 where the fine pattern 13c is formed (FIG. 13 and FIG. 1C), and the other surface 11b of the film substrate 11 and the rigid substrate 14 are laminated (FIG. 20 and FIG. 2E). In the meantime, in the fifth exemplary embodiment, one surface 18b of the film substrate 18 and the rigid substrate 14 are laminated (FIG. 27C and FIG. 23D), and the film substrate 16 and the mold 13 are laminated while having the other surface 18a of the film substrate 18 opposed to the surface 13a of the mold 13 where the fine pattern 13c are formed (FIG. 30H and FIG. 30I). Other structures, functions, and effects of the fifth exemplary embodiment are the same as those of the first to fourth exemplary embodiments.

Hereinafter, the fifth exemplary embodiment will be described in more details. In all of the explanations of the second to fourth exemplary embodiments, described are the methods which provide the pattern-forming resin on the film substrate 18, and provide the rigid substrate 14 on the other-side surface of the above-described film substrate 18 after pressuring the mold 13. Meanwhile, in the fifth exemplary embodiment, the rigid substrate 14 is laminated to the film substrate 18 first, and the mold 13 for transferring the pattern is pressed thereafter.

In the fifth exemplary embodiment, the process after laminating the rigid substrate 14 to the film substrate 18 and then pressuring the mold 13 for transferring the pattern is the same as those of the first to fourth exemplary embodiments. Therefore, the process that overlaps with those of the first to fourth exemplary embodiments is not mentioned herein.

In the first to fourth exemplary embodiments, the film substrate 18 is used in the above-described process by eliminating both protective sheets 24 that are provided in both surfaces of the film substrate 18. This state is not illustrated in the drawings described above. In the meantime, the process is advanced in the fifth exemplary embodiment by exfoliating the protective sheet 24 at point where it becomes necessary to do so.

A PC stamper obtained by forming a land/groove fine pattern for an optical disk on a PC substrate of 0.6 mm in thickness is used as the mold 13 and a PC film substrate of 100 μm in thickness fabricated by an extrusion method is used as the film substrates 18, 21. As the rigid substrates 14 and 20, used are PC substrates of 1.2 mm in thickness with a dummy groove manufactured in a large amount by injection molding, as in the case of the above-described exemplary embodiments. FIG. 27A-FIG. 30I show the procedures for laminating the rigid substrate 14 to the film substrate 18, and pressing the mold 13 for transferring the pattern thereafter.

FIG. 27A: The film substrate 18 having the protective sheet 24 remained on both surfaces is prepared.

FIG. 27B: The protective sheet 24 only on one surface of the film substrate 18 is removed. The protective sheet 24 is simply fixed via an adhesive member, so that it can be easily removed by pressing an adhesive tape on the surface and pulling it up.

FIG. 27C: The ultraviolet curing resin 15 is applied and spread on the film substrate 18, and it is set in the laminating device along with the rigid substrate 14.

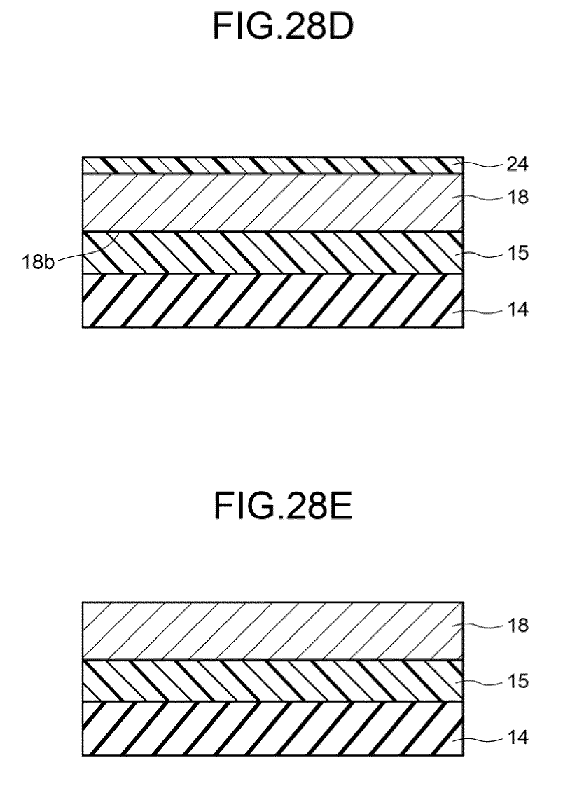

FIG. 28D: The rigid substrate 14 and the film substrate 18 are laminated via the ultraviolet curing resin 15, and the ultraviolet curing resin 15 is cured by radiating the ultraviolet rays.

FIG. 28E: The other protective sheet 24 provided on the film substrate 18 is removed.

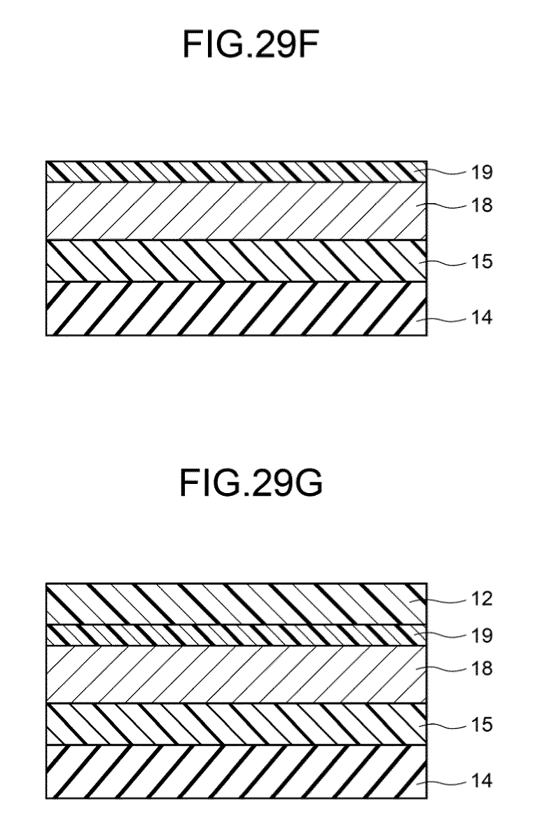

FIG. 29F: The ultraviolet curing resin 19 is applied and spread on the film substrate 18, and the ultraviolet curing resin 19 is cured by radiating the ultraviolet rays.

FIG. 29G: The ultraviolet curing resin 12 is applied and spread on the ultraviolet curing resin 19.

FIG. 30H: The laminate shown in FIG. 29G and the mold 13 are set in the laminating device.

FIG. 30I: The mold 13 is pressed into the ultraviolet curing resin 12, and the ultraviolet curing resin 12 is cured by radiating the ultraviolet rays.

Through a series of procedures described above, the fine pattern of the mold 13 is transferred to the pattern-transferring ultraviolet curing resin 12 on the film substrate 18. The process thereafter is the same as the process after FIG. 10G or the process after FIG. 3F, so that explanations thereof are omitted.

Each of the laminating processes described in the first to fifth exemplary embodiments are all executed by employing the above-described vacuum laminating method in which each of the substrates to be laminated are centered and laminated in vacuum, and ultraviolet rays are radiated from outside in that state to cure the ultraviolet curing resins. However, it has been already verified that those substrates can be laminated with no specific problem with the method in which centering and laminating of the substrates are conducted in the air, through laminating those by controlling not to have air bubbles mixed into the ultraviolet curing resins that are applied to the surfaces to be laminated to each other.

Further, in the first to fourth exemplary embodiments described above, the processes described above are advanced after removing the both protective sheets provided in advance on both surfaces of the film substrate. However, it has been experimentally verified that there is no specific problem, even when the processes are advanced, as necessary, while keeping the protective sheet on the surface to which no ultraviolet curing resin is applied and nothing is to be laminated, and the processes are moved onto a next stage by removing the protective sheet when it comes to a point where the protective sheet is required to be removed.

While the present invention has been described by referring to each of the above-described exemplary embodiments, the present invention is not limited only to each of those exemplary embodiments. Various kinds of modifications that occur to those skilled in the art can be applied to the structures and details of the present invention within the scope of the present invention. Further, the present invention includes combinations of a part of or a whole part of the structures of each of the above-described exemplary embodiments. For example, a thermosetting resin, a thermoplastic resin, an adhesive agent, crimping by heat or ultrasonic waves may be used instead of the ultraviolet curing resin.

Further, the present invention can be expressed as follows.

A first fine-pattern structural body manufacturing method includes: a step of laminating a first film substrate having flexibility in thickness of 300 μm or less and a mold on which a fine pattern is formed in advance by using a first ultraviolet curing resin; a step of laminating a first substrate having rigidity on a surface of the first film substrate, which is the opposite-side surface from the surface to which the mold is laminated, by using a second ultraviolet curing resin that is different from the first ultraviolet curing resin; a step of separating the mold from the first film substrate; a step of forming a functional thin film on the surface of the first film substrate from which the mold is separated; a step of providing a protective film formed with an ultraviolet curing resin on the surface of the first film substrate where the functional thin film is formed; and a step of separating the first substrate from the first film substrate.

A second fine-pattern structural body manufacturing method includes: a step of laminating a first film substrate having flexibility in thickness of 300 μm or less and a mold on which a fine pattern is formed in advance by using a first ultraviolet curing resin; a step of laminating a first substrate having rigidity on a surface of the first film substrate, which is the opposite-side surface from the surface to which the mold is laminated, by using a second ultraviolet curing resin that is different from the first ultraviolet curing resin; a step of separating the mold from the first film substrate; a step of forming a functional thin film on the surface of the first film substrate from which the mold is separated; a step of laminating a second substrate having rigidity that is different from the first substrate and a second film substrate that is different from the first film substrate by using the second ultraviolet curing resin; a step of laminating the surface of the first film substrate where the functional thin film is formed and the surface of the second film substrate, which is the opposite-side surface of the surface to which the second substrate is laminated, by using a third ultraviolet curing resin; a step of separating the first substrate from the first film substrate; and a step of separating the second substrate from the second film substrate.

A third fine-pattern structural body manufacturing method includes: a step of laminating a first film substrate having flexibility in thickness of 300 μm or less and a mold on which a fine pattern is formed in advance by using a first ultraviolet curing resin; a step of laminating a first substrate having rigidity on a surface of the first film substrate, which is the opposite-side surface from the surface to which the mold is laminated, by using a second ultraviolet curing resin that is different from the first ultraviolet curing resin; a step of separating the mold from the first film substrate; a step of forming a functional thin film on the surface of the first film substrate from which the mold is separated; a step of laminating a second substrate having rigidity that is different from the first substrate and a second film substrate that is different from the first film substrate by using the second ultraviolet curing resin; a step of laminating the surface of the first film substrate where the functional thin film is formed and the surface of the second film substrate, which is the opposite-side surface of the surface to which the second substrate is laminated, by using a third ultraviolet curing resin; a step of separating the first substrate having rigidity from the first film substrate; a step of providing a protective film formed with an ultraviolet curing resin on the surface of the first film substrate from which the first substrate is separated; and a step of separating the second substrate from the second film substrate.

A fourth fine-pattern structural body manufacturing method includes: a step of laminating a first film substrate having flexibility in thickness of 300 μm or less and a mold on which a fine pattern is formed in advance by using a first ultraviolet curing resin; a step of laminating a first substrate having rigidity to a surface of the first film substrate, which is the opposite-side surface from the surface to which the mold is laminated, by using a second ultraviolet curing resin that is different from the first ultraviolet curing resin; a step of separating the mold from the first film substrate; a step of forming a functional thin film on the surface of the first film substrate from which the mold is separated; a step of laminating a second substrate having rigidity that is different from the first substrate and a second film substrate that is different from the first film substrate by using the second ultraviolet curing resin; a step of laminating the surface of the first film substrate where the functional thin film is formed and the surface of the second film substrate, which is the opposite-side surface of the surface to which the second substrate is laminated, by using a third ultraviolet curing resin; a step of separating the second substrate from the second film substrate; a step of providing a protective film formed with an ultraviolet curing resin on the surface of the second film substrate from which the second substrate is separated; and a step of separating the first substrate from the first film substrate.

A fifth fine-pattern structural body manufacturing method is so characterized that the step of laminating the first film substrate to the mold by using the first ultraviolet curing resin according to the first to the fourth fine-pattern structural body manufacturing methods includes a step of deriving a center point of the first film substrate and a step of deriving a center point of the mold, wherein the first film substrate and the mold are laminated in such a manner that the center point of the first film substrate and the center point of the mold match with each other.

A sixth fine-pattern structural body manufacturing method is so characterized that the step of laminating the first substrate to the surface of the first film substrate, which is the opposite-side surface from the surface to which the mold is laminated, by using the second ultraviolet curing resin according to the first to fourth fine-pattern structural body manufacturing methods includes a step of deriving a center point of the first film substrate and a step of deriving a center point of the first substrate, wherein the first substrate and the surface of first film substrate, which is the opposite-side surface of the surface where the mold is laminated, are laminated in such a manner that the center point of the first film substrate and the center point of the first substrate match with each other.

A seventh fine-pattern structural food manufacturing method is so characterized that the step of laminating the second substrate to the second film substrate by using the second ultraviolet curing resin according to the second to fourth fine-pattern structural body manufacturing methods includes a step of deriving a center point of the second substrate and a step of deriving a center point of the second film substrate, wherein the second film substrate and the second substrate are laminated in such a manner that the center point of the second film substrate and the center point of the second substrate match with each other.

An eighth fine-pattern structural food manufacturing method is so characterized that the step of laminating the surface of the first film substrate where the functional thin film is formed and the surface of the second film substrate, which is the opposite-side surface of the surface to which the second substrate is laminated by using the third ultraviolet curing resin according to the second to fourth fine-pattern structural body manufacturing methods includes a step of deriving a center point of the second film substrate and deriving a center point of the first film substrate, wherein the second film substrate and the first film substrate are laminated in such a manner that the center point of the second film substrate and the center point of the first film substrate match with each other.

A ninth fine-pattern structural body manufacturing method includes: a step of laminating a first film substrate having flexibility in thickness of 300 μm or less and a first substrate having rigidity by using a second ultraviolet curing resin; a step of laminating a mold having a fine pattern formed thereon in advance to a surface of the first film substrate, which is an opposite-side surface from the surface where the first substrate is laminated, by using a first ultraviolet curing resin; a step of separating the mold from the first film substrate; a step of forming a functional thin film on the surface of the first film substrate from which the mold is separated; a step of providing a protective film formed with an ultraviolet curing resin on the surface of the first film substrate where the functional thin film is formed; and a step of separating the first substrate from the first film substrate.

A tenth fine-pattern structural body manufacturing method includes: a step of laminating a first film substrate having flexibility in thickness of 300 μm or less and a first substrate having rigidity by using a second ultraviolet curing resin; a step of laminating a mold having a fine pattern formed thereon in advance to surface of the first film substrate, which is an opposite-side surface from the surface where the first substrate is laminated, by using a first ultraviolet curing resin; a step of separating the mold from the first film substrate; a step of forming a functional thin film on the surface of the first film substrate from which the mold is separated; a step of laminating a second substrate having rigidity that is different from the first substrate and a second film substrate that is different from the first film substrate by using the second ultraviolet curing resin; a step of laminating the surface of the first film substrate where the functional thin film is formed and the surface of the second film substrate, which is the opposite-side surface of the surface to which the second substrate is laminated, by using a third ultraviolet curing resin; a step of separating the first substrate from the first film substrate; and a step of separating the second substrate from the second film substrate.

An eleventh fine-pattern structural body manufacturing method includes: a step of laminating a first film substrate having flexibility in thickness of 300 μm or less and a first substrate having rigidity by using a second ultraviolet curing resin; a step of laminating a mold having a fine pattern formed thereon in advance to surface of the first film substrate, which is an opposite-side surface from the surface where the first substrate is laminated, by using a first ultraviolet curing resin; a step of separating the mold from the first film substrate; a step of forming a functional thin film on the surface of the first film substrate from which the mold is separated; a step of laminating a second substrate having rigidity that is different from the first substrate and a second film substrate that is different from the first film substrate by using the second ultraviolet curing resin; a step of laminating the surface of the first film substrate where the functional thin film is formed and the surface of the second film substrate, which is the opposite-side surface of the surface to which the second substrate is laminated, by using a third ultraviolet curing resin; a step of separating the first substrate from the first film substrate; a step of providing a protective film formed with an ultraviolet curing resin on the surface of the first film substrate from which the first substrate is separated; and a step of separating the second substrate from the second film substrate.

A twelfth fine-pattern structural body manufacturing method includes: a step of laminating a first film substrate having flexibility in thickness of 300 μm or less and a first film substrate having rigidity by using a second ultraviolet curing resin; a step of laminating a mold having a fine pattern formed thereon in advance to surface of the first film substrate, which is an opposite-side surface from the surface where the first substrate is laminated, by using a first ultraviolet curing resin; a step of separating the mold from the first film substrate; a step of forming a functional thin film on the surface of the first film substrate from which the mold is separated; a step of laminating a second substrate having rigidity that is different from the first substrate and a second film substrate that is different from the first film substrate by using the second ultraviolet curing resin; a step of laminating the surface of the first film substrate where the functional thin film is formed and the surface of the second film substrate, which is the opposite-side surface of the surface to which the second substrate is laminated by using a third ultraviolet curing resin; a step of separating the second substrate from the second film substrate; a step of providing a protective film formed with an ultraviolet curing resin on the surface of the second film substrate from which the second substrate is separated; and a step of separating the first substrate from the first film substrate.

A thirteenth fine-pattern structural body manufacturing method is so characterized that the step of laminating the first film substrate and the first substrate by using the second ultraviolet curing resin according to the ninth to twelfth fine-pattern structural body manufacturing methods includes a step of deriving a center point of the first film substrate and a step of deriving a center point of the first substrate, wherein the first film substrate and the first substrate are laminated in such a manner that the center point of the first film, substrate and the center point of the first substrate match with each other.

A fourteenth fine-pattern structural body manufacturing method is so characterized that the step of laminating the mold having the fine pattern formed thereon in advance to the surface of the first film substrate, which is the opposite-side surface from the surface where the first substrate is laminated, by using the first ultraviolet curing resin according to the ninth to twelfth fine-pattern structural food manufacturing methods includes a step of deriving a center point of the first film substrate and a step of deriving a center point of the mold, wherein the first film substrate and the mold are laminated in such a manner that the center point of the first film substrate and the center point of the mold match with each other.

A fifteenth fine-pattern structural body manufacturing method is so characterized that the step of laminating the second substrate having rigidity that is different from the first substrate and the second film substrate that is different from the first film substrate by using the second ultraviolet curing resin according to the tenth to twelfth fine-pattern structural body manufacturing methods includes a step of deriving a center point of the second substrate and a step of deriving a center point of the second film substrate, wherein the second film substrate and the second substrate are laminated in such a manner that the center point of the second film substrate and the center point of the second substrate match with each other.

A sixteenth fine-pattern structural body manufacturing method is so characterized that the step of laminating the surface of the first film substrate where the functional thin film is formed and the surface of the second firm substrate, which is the opposite-side surface of the surface to which the second substrate is laminated by using the third ultraviolet curing resin according to the tenth to twelfth fine-pattern structural body manufacturing methods includes a step of deriving a center point of the second film substrate and a center point of the first film substrate, wherein the second film substrate and the first film substrate are laminated in such a manner that the center point of the second film substrate and the center point of the first film substrate match with each other.

A seventeenth fine-pattern structural body manufacturing method is so characterized that the relation in terms of the size of each inner diameter of the first film substrate, the second film substrate, the mold, the first substrate, and the second substrate according to the first to sixteenth fine-pattern structural body manufacturing methods satisfies “(inner diameter of the first film substrate=inner diameter of the second film substrate)<(inner diameter of the first substrate=inner diameter of the second substrate” and “(inner diameter of the first film substrate=inner diameter of the second film substrate)<inner diameter of the mold”.

An eighteenth fine-pattern structural body manufacturing method is so characterized that, in the step of forming the functional thin film on the first film substrate from which the mold is separated according to the first to forth and ninth to twelfth fine-pattern structural body manufacturing methods, the functional thin film is an optical information recording film that is capable of recording or reproducing information by radiation of laser beams.

The fine-pattern structural body is characterized to be fabricated by using one of the first to eighteenth fine-pattern structural body manufacturing methods.

The present invention has been designed in view of the issues of the related technique. It is therefore an exemplary object of the present invention to provide a manufacturing method of a fine-pattern structural body which is excellent in handling property because the thin-type film substrate is supported by a substrate having rigidity simultaneously with transfer and formation of the fine pattern, which has no eccentricity with respect to the center of the transferred substrate since the mold and the film substrate to which the fine pattern is transferred are laminated by having the both center points match with each other, and which has no defect caused by mixture of air bubbles or the like. It is also an exemplary object of the invention to stably provide the fine-pattern structural bodies obtained by using such method.

The present invention provides following effects. The thin-type film substrate is supported by the substrate having rigidity simultaneously with transfer and formation of the fine pattern, so that handling of the thin-type film substrate becomes easy. After forming and transferring the fine pattern, it is unnecessary to provide the protective sheet or the like again on the pattern transferred surface. The thin-type film substrate is laminated to the rigid substrate by the ultraviolet curing resin and supported thereby. Thus, even if it is set in vacuum, no air bubble is generated in the laminated surface. Therefore, it is possible to obtain the fine pattern without a defect. At the time of transferring the pattern, the mold and the film substrate to which the fine pattern is transferred can be laminated by having the center points of the both matched with each other. Therefore, there is no eccentricity generated.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

### INDUSTRIAL APPLICABILITY

The present invention can be utilized to micromachining technology such as micro processing when manufacturing storage devices, optical devices, bio devices, semiconductor devices, and the like.

What is claimed is:

1. A fine-pattern structural body manufacturing method, comprising:
laminating a first film substrate having flexibility and a mold having a fine pattern formed thereon in such a manner that one surface of the first film substrate and a surface of the mold where the fine pattern is formed face with each other;
laminating other surface of the first film substrate and a first rigid substrate having rigidity;
separating the mold from the first film substrate;
forming a functional thin film on the surface of the first film substrate from which the mold is separated;
forming a protective film on the functional thin film; and
separating the first rigid substrate from the first film substrate.

2. The fine-pattern structural body manufacturing method as claimed in claim 1, comprising, instead of forming the protective film on the functional thin film after forming the functional thin film on one of the surfaces of the first film substrate:
laminating one surface of a second film substrate and a second rigid substrate having rigidity;
laminating the surface of the first film substrate where the functional thin film is formed and other surface of the second film substrate; and
separating the first rigid substrate and the second rigid substrate from the first film substrate and the second film substrate, respectively.

3. The fine-pattern structural body manufacturing method as claimed in claim 2, comprising, when separating the first rigid substrate and the second rigid substrate from the first film substrate and the second film substrate, respectively:
separating the first rigid substrate from the first film substrate; forming a protective film on one of the surface of the first film substrate; and separating the second rigid substrate from the second film substrate.

4. The fine-pattern structural body manufacturing method as claimed in claim 2, comprising, when separating the first rigid substrate and the second rigid substrate from the first film substrate and the second film substrate, respectively:
separating the second rigid substrate from the second film substrate; forming a protective film on one of the surface of the second film substrate; and separating the first rigid substrate from the first film substrate.

5. The fine-pattern structural body manufacturing method as claimed in claim 1, comprising, when laminating the first film substrate and the mold in such a manner that one surface of the first film substrate and the surface of the mold where the fine pattern is formed face with each other:
deriving a center point of the first film substrate and a center point of the mold; and laminating the first film substrate and the mold in such a manner that the center points of the both match with each other.

6. The fine-pattern structural body manufacturing method as claimed in claim 1, comprising, when laminating the other surface of the first film substrate and the first rigid substrate:
deriving a center point of the first film substrate and a center point of the first rigid substrate; and laminating the first film substrate and the first rigid substrate in such a manner that the center points of the both match with each other.

7. The fine-pattern structural body manufacturing method as claimed in claim 2, comprising, when laminating one of the surfaces of the second film substrate and the second rigid substrate:
deriving a center point of the second film substrate and a center point of the second rigid substrate; and laminating the second film substrate and the second rigid substrate in such a manner that the center points of the both match with each other.

8. The fine-pattern structural body manufacturing method as claimed in claim 2, comprising, when laminating the surface of the first film substrate where the functional thin film is formed and the other surface of the second film substrate;
deriving a center point of the first film substrate and a center point of the second film substrate; and laminating the first film substrate and the second film substrate in such a manner that the center points of the both match with each other.

9. The fine-pattern structural body manufacturing method as claimed in claim 1, comprising, instead of laminating the first film substrate and the mold in such a manner that one of the surfaces of the first film substrate and the surface of the mold where the fine pattern is formed face with each other, and laminating the other surface of the first film substrate and the first rigid substrate:
laminating the other surface of the first film substrate and the first rigid substrate; and laminating the first film substrate and the mold in such a manner that one of the surfaces of the first film substrate and the surface of the mold where the fine pattern is formed face with each other.

10. The fine-pattern structural body manufacturing method as claimed in claim 1, wherein:
each of the first film substrate, the mold, and the first rigid substrate has a circular through hole at each center point, and a relation in terms of size regarding diameters of the through holes satisfies
the through hole of the first film substrate<the through hole of the first rigid substrate, and
the through hole of the first film substrate<the through hole of the mold.

11. The fine-pattern structural body manufacturing method as claimed in claim 2, wherein:
each of the first film substrate, the second film substrate, the mold, the first rigid substrate, and the second rigid substrate has a circular through hole at each center point, and a relation in terms of size regarding diameters of the through holes satisfies
(the through hole of the first film substrate=the through hole of the second film substrate)<(the through hole of the first rigid substrate=the through hole of the second rigid substrate), and
(the through hole of the first film substrate=the through hole of the second film substrate)<the through hole of the mold.

12. The fine-pattern structural body manufacturing method as claimed in claim 1, wherein an ultraviolet curing resin is used for laminating the substrates and the mold.

13. The fine-pattern structural body manufacturing method as claimed in claim 1, wherein the functional thin film is an optical information recording film capable of recording or reproducing information by radiation of laser beams.

14. The fine-pattern structural body manufacturing method as claimed in claim 1, wherein thickness of the first film substrate is 300 μm or less.

15. The fine-pattern structural body manufacturing method as claimed in claim 2, wherein thickness of the second film substrate is 300 μm or less.

16. A fine-pattern structural body which is obtained through:
laminating a first film substrate having flexibility and a mold having a fine pattern formed thereon in such a manner that one surface of the first film substrate and a surface of the mold where the fine pattern is formed face with each other;
laminating other surface of the first film substrate and a first rigid substrate having rigidity;
separating the mold from the first film substrate;
forming a functional thin film on the surface of the first film substrate from which the mold is separated;
forming a protective film on the functional thin film; and
separating the first rigid substrate from the first film substrate.

17. The fine-pattern structural body as claimed in claim 16, which is obtained through, instead of forming the protective film on the functional thin film after forming the functional thin film on one of the surfaces of the first film substrate:
laminating one surface of a second film substrate and a second rigid substrate having rigidity;
laminating the surface of the first film substrate where the functional thin film is formed and other surface of the second film substrate; and
separating the first rigid substrate and the second rigid substrate from the first film substrate and the second film substrate, respectively.
